(19) United States
(12) Patent Application Publication
(10) Pub. No.: US 2024/0198827 A1
(43) Pub. Date: Jun. 20, 2024

(54) Electric Vehicle Smart Charging Stations

(71) Applicant: Voltpost, Inc., New York, NY (US)

(72) Inventors: Joern Vicari, San Francisco, CA (US); Jeffrey Prosserman, Brooklyn, NY (US); Alejandro Vallejo, Oakley, CA (US)

(21) Appl. No.: 18/287,997

(22) PCT Filed: Apr. 20, 2023
(86) PCT No.: PCT/US2022/025504

§ 371 Date: Oct. 23, 2023

Related U.S. Application Data
(60) Provisional application No. 63/177,551, filed on Apr. 21, 2021.

(51) Int. Cl. B60L 53/31; B60L 53/18; B60L 53/30; B60L 53/62; B60L 53/66

(52) U.S. Cl. CPC B60L 53/31; B60L 53/18; B60L 53/62; B60L 53/305; B60L 53/665

(57) ABSTRACT

A system with a technical unit having modules that, when assembled, surround a periphery of a lamppost, at least one of the modules having an electric charging function capability, a non-charging function capability, or a communications function capability. The system may be charging station for charging an electric vehicle from a power source inside the lamppost may include a base unit to surround the base of the lamppost.

### RELATED APPLICATION INFORMATION

The present application claims priority to and the benefit of U.S. Provisional Patent Application No. 63/177,551 filed Apr. 21, 2021, which is incorporated herein by reference to the extent permitted by law.

### FIELD

The present disclosure relates to the field of electric vehicle charging stations. It also relates to the retrofitting of existing lampposts and other poles wired with power cables with functional units.

### BACKGROUND

Greenhouse gases (GHG) made this past decade the hottest ever recorded. Temperature rise at this level generates dangerous impacts to environmental ecosystems that threaten human survival. Transportation accounts for 31% of GHG emissions across the United States. Globally, transportation is 16% of total emissions with internal combustion engine light-duty vehicles as the largest source of these emissions.

Currently about 2% of total cars across the United States are electric. Installing reliable access to charging stations on residential city streets, rather than just in central locations such as shopping malls, is critical to increase adoption. According to the U.S. Department of Energy, over 80% of electric vehicle (EV) charging happens at home. However, the majority of city cars park on the street. Although many city residents want to purchase electric vehicles, the top adoption barrier is the lack of public charging stations causing range anxiety. Convenient public charging access is needed for drivers without garages.

### SUMMARY

This Summary is provided to introduce a selection of concepts in a simplified form that are further described below in the Detailed Description. This Summary is not intended to identify key aspects or essential aspects of the claimed subject matter.

This disclosure provides generally, a function unit with modules that can be mounted on a lamppost, lamp pole, light pole, or other pole wired with power cables with the modules of the function unit surrounding the lamppost. While, in general, the disclosed principles have initial applicability to lampposts, they also are applicable to other situations involving poles wired with power cables. It is to be understood that while references herein are mainly to lampposts, the concepts encompass other poles wired with power cables, with “lampposts” being a subset of the more generic term “poles.” As defined below, only two of the modules need have the same dimensions, although it is preferred that more than two or all of the modules have the same dimensions. For example, some of the modules might be dimensioned such that two or more of them having a first set of dimensions can be exchanged for a module having a second set of dimensions. Further, the modules need not have the same functional capabilities. A module of such a station can include a charging function capability. Alternatively, a module can have no function capability. Yet further, a module can include a non-charging function capability such as a cellular signal radio unit, an environmental condition sensing capability (e.g., to measure a weather condition, allergen condition, or pollution condition, to name a few), or a non-environmental condition sensing capability (e.g., a proximity sensor, a camera, audio and/or visual functions, or and RFID sensor, to name a few).

The following definitions are provided for terms used herein:

“Charging function capability” means operatively configured to effect and control the delivery of wired or wireless electrical charging power.

“Non-charging function capability” means operatively configured to effect a function other than delivery and control of delivery of electrical charging power, such as an environmental condition sensing capability, a non-environmental condition sensing capability, or a communications function capability.

“Environmental condition sensing capability” means having one or more sensors that can sense an environmental condition such as temperature, humidity, air pressure, precipitation, pollen, air ionization, radioactivity levels, toxic particles, air borne contaminants, and smoke.

“Non-environmental condition sensing capability” means having one or more sensors that can sense a condition other than an environmental condition such as a radio frequency identifier (RFID tags), electromagnetic information, proximity, visual information, and audio/audible information.

“Communications function capability” means operatively configured to receive or deliver a communication such as a panic alert, a public address communication, a voiced communication, machine or device to machine or device communication, network peerage communication, a wireless (e.g., Wi-Fi®, Bluetooth®, or other standard) communication, or an audible communication such as an alarm).

“No function capability” means devoid of a charging function capability, a non-charging function capability, and a communications function capability.

“Lamppost” means a structure with a pole configured for holding up a light and includes lamp poles and light poles.

“Module” means, in the context other than software or circuitry, a physical unit of a function unit or technical unit, which when assembled with other modules surround a periphery of a lamppost pole. The units preferably are, but need not be, modular. In the context of software or circuitry, the term has its normally accepted meaning.

“Modular” means that two or more, but not necessarily all, modules of a function unit or a technical unit have the same dimensions and are physically or mechanically interchangeable in the same space. The space may be occupied by two or more modules having other dimensions.

“Function unit” or “technical unit” means an assembly of modules, at least one of which as a charging function capability, a non-charging function capability, or a communications function capability.

This description also relates in part to systems used to transform city lampposts into public electric vehicle smart charging stations that can be managed by a mobile application that can appear on a smart phone or an in-car display. These systems use the existing infrastructure by retrofitting lampposts that are already on public streets or in parking lots. These EV charging systems can be located curbside on city streets where drivers currently park to increase access to charging and reduce friction. By retrofitting existing lampposts, the systems fits in diverse public spaces without taking up additional space in the built environment. The design includes responsive LED lights that indicate charging status, an electricity meter to track electricity consumption, connectivity to mobile phones, and a pedestrian-friendly charging socket. Such systems reduce the footprint, timing, and cost of charging station deployment.

The mobile application provides drivers access to power from the electric grid with available station discovery, booking, charging, billing, and impact features. Via the mobile application, drivers gain visibility of charging stations on a map, reserve a charging station in advance, track charging progress remotely, pay based on electricity consumed, and gain insights on financial and environmental savings. Via the well-known Open Charge Point Protocol (see, openchargealliance.org), the location of charging stations can surface on the mobile application and other in-car display systems and applications.

In some embodiments, a charging system for use with a lamppost for charging an electric vehicle (EV) from a power source inside the lamppost is described that includes a base unit configured to surround a base of the lamppost, the base unit comprising a first base portion and a second base portion that are configured to connect to each other and thereby surround the base of the lamppost and a functional or technical unit configured to surround an upper portion of the lamppost. The technical unit has a shell configured to surround the upper portion of the lamppost and to house electronic components therein, the electronic components being electrically connected to the power source inside the lamppost, and at least one charging port accessible from outside the shell and configured to allow a charging plug to be attached thereto and thereby electrically connect the charging plug to the power source inside the lamppost, wherein the shell has a first half and a second half that are configured to connect to each other and to the upper portion of the lamppost and thereby enclose the upper portion of the lamppost.

Embodiments can include one or more of the following features: one of the first base portion and the second base portion comprises an access door. The at least one charging port comprises a charging port light. The charging port light is configured to change color when the charging plug is connected to the charging port. The light is an LED. The charging port is a J plug. The electronic components are mounted on a component housing within the shell. The electronic components comprise a power meter configured to measure the power being used at the at least one charging port. A communication system configured to communicate the power being used at the at least one charging port. A motorized charging port door that moves between a closed-charging port position to an open-charging port position. Gaskets that create a liquid seal and separates an interior and an exterior of the technical unit. The gaskets include an upper gasket that seals an upper edge of the technical unit from the exterior of the technical unit. The gaskets include a central gasket that mates with a hook that at least partly attaches the technical unit to the lamppost. A light that shows a status of the charging station. The light is an LED. The charging port is a Level 1 charging port. The charging port is a Level 2 charging port.

In some embodiments, an electric vehicle (EV) charging system, includes a charging station as described above, a communication network configured to receive electricity usage information from an electric meter inside the technical unit, a charge manager connected to the communication network, configured to analyze the usage information received from the technical unit, and a mobile application configured to allow a user to us the charging station.

In an embodiment, an electric charging station comprises:
a lower bracket that can be secured to a pole at a first position at or above a base of the pole;
an upper bracket that can be secured to the pole at a second position spaced apart and above the first position;
a plurality of function unit modules that can be secured to the upper bracket to surround the pole and be supported on the lower bracket, at least one function unit module having a charging function capability.

In an embodiment, the pole is a lamppost.

In an embodiment, the electric charging station comprises a base unit with portions that can be assembled about a base of the pole, one of the portions comprising an access door.

In an embodiment, all of the function unit modules have a charging function capability.

In an embodiment, the at least one function unit module comprises an electronic display with a transparent bullet proof pane overlaying the electronic display.

In an embodiment, the at least one function unit comprises a lockable door.

In an embodiment, the at least one function unit module comprises a retractable charging cable which is accessible once the lockable door is in an open position.

In an embodiment, an charging system comprises:
a lower bracket secured to a pole at a first position at or above a base of the pole;
an upper bracket secured to the pole at a second position spaced apart and above the first position;
a base unit comprised of a plurality of portions secured to the lower bracket and surrounding the pole base; and
a function unit comprised of a plurality of modules secured to the upper bracket and surrounding the pole and supported on the base unit, at least one of the modules having a charging function capability.

In an embodiment, the pole is a lamppost.

In an embodiment, one of the charging station base unit portions comprises an access door.

In an embodiment, all of the charging station modules are capable of providing electric charging power to the vehicle.

In an embodiment, the at least one of the charging station modules comprises an electronic display with a transparent bullet proof pane overlaying the electronic display.

In an embodiment, the at least one of the charging station modules comprises a motorized door.

In an embodiment, the at least one of the charging station modules comprises a retractable charging cable which is accessible once the motorized door is in an open position.

In an embodiment, the at least one of the charging station modules comprises a retractable charging cable.

In an embodiment, a system comprises:
a lower bracket that can be secured to a pole at a first position at or above a base of the pole;
an upper bracket that can be secured to the pole at a second position spaced apart and above the first position; and
a function unit comprising modules that can be secured to the upper bracket to surround the pole and be supported on the lower bracket, at least one of the modules having a charging function capability, a non-charging function capability, or a communications function capability.

In an embodiment, the pole is a lamppost.

In an embodiment, at least two of the modules are modular.

In an embodiment, the system includes a base unit with panels that can be secured to the lower bracket and to each other to surround a base of the lamppost.

In an embodiment, at least one of the modules has a charging function capability.

In an embodiment, at least one of the modules has a non-charging function capability.

In an embodiment, at least one of the modules has a communications function capability.

Advantages of the systems described herein accrue due to quick installation of non-invasive components on existing city infrastructure and so maintain the smallest possible footprint, with a design approach that blends naturally into neighborhoods. These systems transform city lampposts into public electric vehicle charging stations to increase mainstream adoption and achieve national, state, and city decarbonization targets. The system components are constructed with weatherproof materials, and so are rugged, durable, and low in overall maintenance costs over the long term.

All features of exemplary embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

FIG. 1 is a schematic of an electric vehicle charging system.

FIG. 2 is a schematic of portions of the electric vehicle charging system of FIG. 1.

FIG. 3 is a partial exploded diagram of hardware portions of the electric vehicle charging system of FIG. 1.

FIG. 4 is a partial exploded diagram of upper hardware portions of the electric vehicle charging system of FIG. 1.

FIGS. 5A-5D are illustrate the use of hardware by a user using the electric vehicle charging system of FIG. 1.

FIG. 6 is a schematic of the cloud-based charge management system 200 used as part of an electric vehicle charging system.

FIG. 7 is a perspective partial exploded view of a lamppost being fitted with brackets for another embodiment.

FIG. 8 is a perspective partial exploded view of the lamppost of FIG. 7 to which lower panels of a base unit are to be attached.

FIG. 9 illustrates assembly of base unit.

FIG. 10 illustrates an assembled base unit.

FIG. 11 is a perspective partial exploded view the lamppost of FIG. 7 to which function unit modules are to be mounted.

FIG. 12 is a perspective view of the lamppost of FIG. 7 with an assembled function unit.

FIG. 13 is a perspective view of the lamppost of FIG. 7 illustrating function unit modules prior to assembly of the function unit.

FIGS. 13a and 13b illustrate one way in which a function unit module can with a supporting bracket.

FIG. 14 illustrates details of the assembly of the function unit.

FIG. 15 is a perspective view of a portion of a lamppost illustrating a portion of the electrical wiring before installation of a system embodying principles disclosed herein.

FIG. 16 is a perspective view of the portion of the lamppost of FIG. 11 illustrating the portion of the electrical wiring as modified to accommodate a function unit.

FIG. 17 is a block diagram of a control system for controlling operation of a module having a charging function capability.

FIGS. 18-20 illustrate a wireless charging system for vehicles.

FIG. 21 illustrates a system having a function unit in which two of the modules have non-charging function capabilities.

FIGS. 22-25 illustrates a charging system for micro mobility devices.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

This description relates in part to systems used to transform city lampposts into, among other things, public electric vehicle smart charging stations that can be managed, e.g. by a mobile application that can appear on a smart phone or an in-car display. These systems use the existing infrastructure by retrofitting lampposts that are already on public streets. These EV charging systems can be located curbside on city streets where drivers currently park to increase access to charging and reduce friction. By retrofitting existing lampposts, the systems fits in diverse public spaces without taking up additional space in the built environment. The design includes responsive LED lights that indicate charging status, an electricity meter to track electricity consumption, connectivity to mobile phones, and a pedestrian-friendly charging socket. Such systems reduce the footprint, timing, and cost of charging station deployment.

This description also relates in part to modular stations mounted on lamppost poles in which a plurality (two or more) of modules matingly surround the poles. One or more of the modules can have a charging function capability. One or more of the modules can have a non-charging function capability. One or more of the modules can have no function capability. One or more of the modules can have a communications function capability.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer, or section. Thus, a first element, component, region, layer, or section discussed below could be termed a second element, component, region, layer, or section without departing from various teachings of this disclosure.

Terminology used herein is for describing particular embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

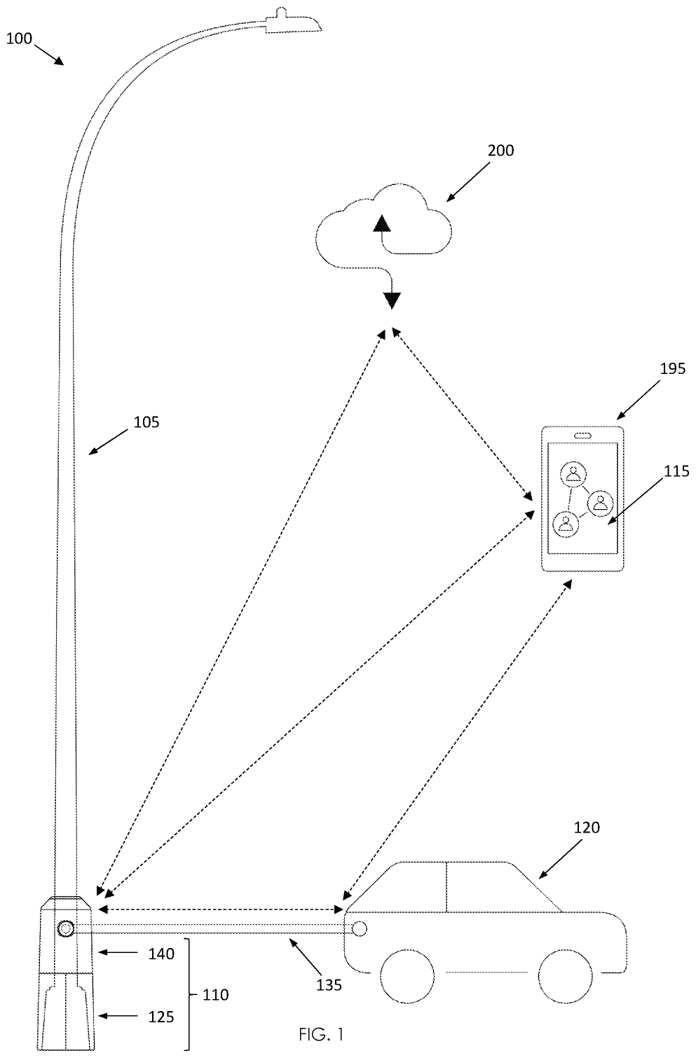

FIG. 1 illustrates the primary components of an electric vehicle charging system 100 that transforms a standard city sidewalk lamppost 105 into a smart electric vehicle (EV) charging station 110 for charging a vehicle 120. The EV charging station 110 retrofits the existing lamppost 105 by surrounding the base of the lamppost 105 with a modular protective base unit 125 and a user-interactive technical unit 140 into which the user can plug a charging cable 135 to charge their vehicle 120 (e.g., their electric vehicle or hybrid vehicle). The EV charging station 110 is managed by a mobile application 115 that runs on a mobile device 195 such as a smart phone or an in-car display and enables a cloud-based charge management system 200 for charging the vehicle 120. Data is transferred between the EV charging station 110 and the vehicle 120 via the cloud-based charge management system 200. In some embodiments, there is Bluetooth connectivity between the EV charging station 110 and the mobile device 195. The EV charging station 110 is designed to be integrated into existing lampposts with quick installation is used to reduce the footprint, timing, and cost of charging station deployment in cities.

### Hardware Description

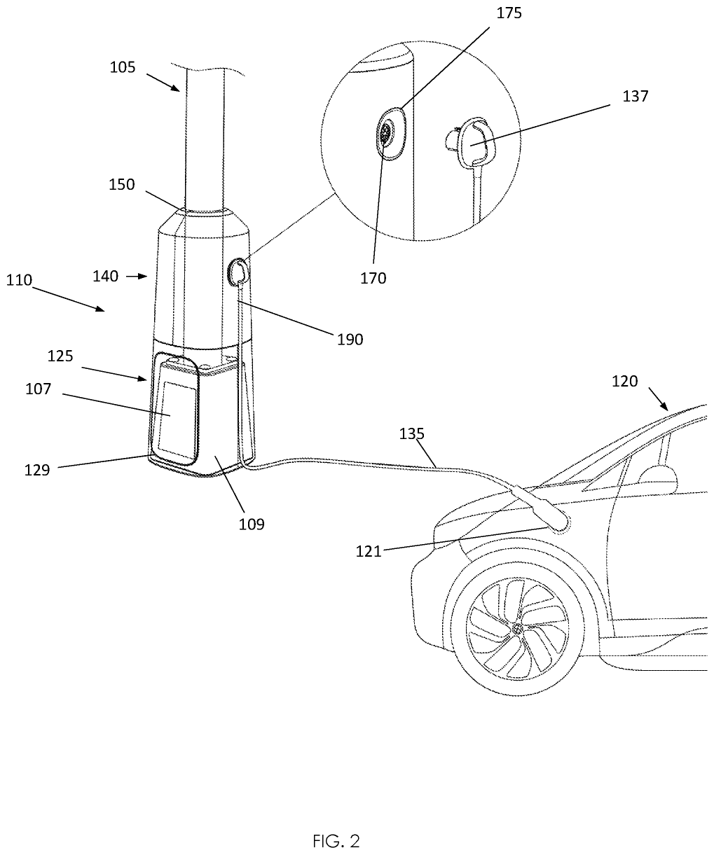

FIG. 2 is a schematic illustrating hardware portions of the electric vehicle charging system 100 of FIG. 1, namely the EV charging station 110 housing and components that encase the lamppost 105. The EV charging station 110 includes the base unit 125 and the technical unit 140. Each of the base unit 125 and the shell or housing of the technical unit 140 are formed of symmetrical halves that surround and fit together around the lamppost 105. The base unit 125 halves rest on the ground, and the technical unit 140 halves rest on the base unit 125 and also hook onto the lamppost 105 using a clamp and gasket system that accounts for differing lamppost shapes.

The lower base unit 125 is separate from the upper technical unit 140 and rests on the sidewalk. The lower base unit 125 encases the base of the lamppost 105 and has an access door 129 that when fitted onto the lamppost 105 can be oriented so that the access door 129 aligns with the preexisting lamppost access 107 of the lamppost base 109 that permits access to the inside of the lamppost 105. Encasing the lamppost 105 in this manner allows technicians to reach through the lamppost access 107 for power connection of the technical unit 140 to the power grid without drilling access holes into the lamppost 105. Aligning the access door 129 with the lamppost access also allows city technicians to service the lamppost 105 as needed without disrupting the technical components of the EV charging station 110 that are in the technical unit 140. In some embodiments, a small hole can be drilled into the existing lamppost 105 to accommodate varying lamppost design including those without an access door 129. Cabling can also be wired up the lamppost 105 for overhead electric wiring configurations.

The EV charging station 110 uses a detachable custom charging cable 135 that attaches to the charging port 121 of the vehicle 120 at one end and the charging port 170 of the technical unit 140 on the other end. The charging port 170 can include an LED light ring 175 surrounding the port that can guide and provide information to the user plugging in the charging plug 137. When the charging plug 137 is plugged into the charging port 170, magnetic cable guides 190 can hold the charging cable 135 close to the EV charging station 110 and reduce the risk of trip hazards. More specifically, the magnetic cable guides can include two components that are magnetically attracted to each other to maintain the charging cable in the orientation shown in FIG. 2, that is, the cable runs vertically down while remaining in contact with the wall of the technical unit 140 and with the wall of the lower base unit 125. In a specific example of implementation, the sheath of the charging cable can include magnetic material embedded therein, while the outer walls of the technical unit 140 and of the lower base unit include magnetic material arranged such as to attract the sheath and maintain the charging cable in the position shown, or in any other desired position. In the specific example illustrated in FIG. 2, the arrangement of magnetic material on the technical unit 140 and of the lower base unit 125 runs vertically hold the cable in that orientation.

Also note that the orientation of the charging cable as it projects from the connection 137 on the technical unit 140 is selected such that it is aligned with the desired cable path, that is downwardly.

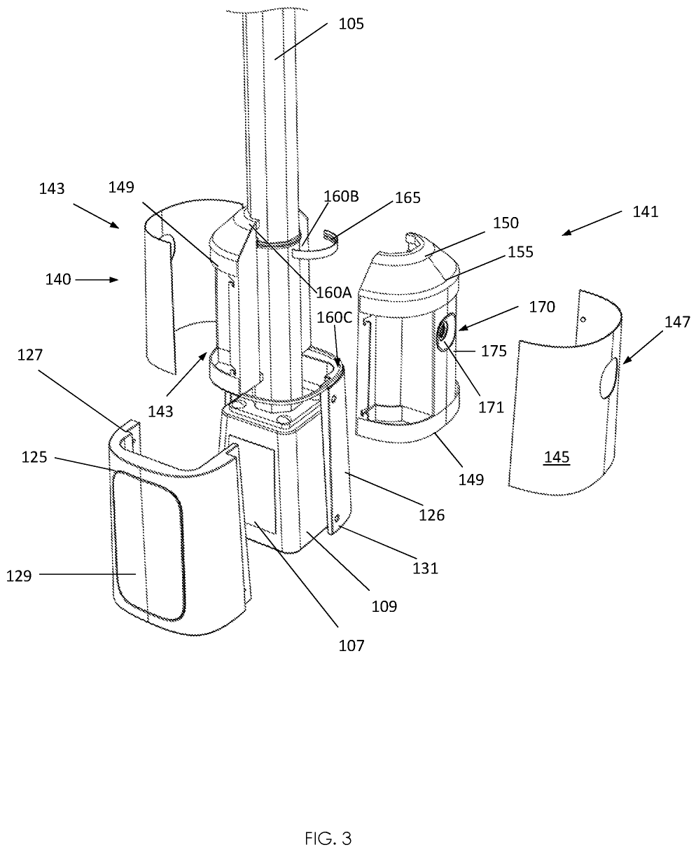

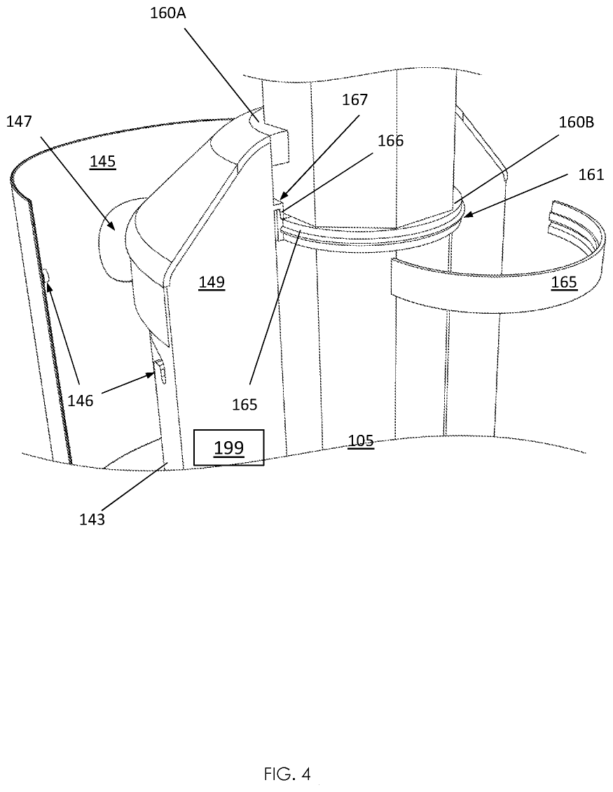

The various components that allow the base unit 125 and the separate technical unit 140 to attach to the lamppost 105 are shown in more detail in FIGS. 3 and 4.

FIG. 3 shows the base unit 125 in its two halves, where the first base half 126 is positioned around the lamppost base 109 and the second base half 127 shown away from the lamppost base 109. In the embodiment shown, the second base half 127 has the access door 129 that permits access to the lamppost access 107 and thereby the insides of the lamppost 105. The first base half 126 and the second base half 127 can be sized and shaped to fit around a standard lamppost base 109, or the two base halves can come in different sizes so as to fit around differently sized lamppost bases 109. The base unit 125 can be configured so that the first base half 126 and the second base half 127 fit together using any combination of interlocking parts and fasteners as is known in the art such as screws 131. The base unit 125 is typically made of rugged material that is waterproof and can protect the interior of the base unit 125. For example, the first base half 126 and the second base half 127 can be made primarily of concrete.

The technical unit 140 is configured to house the electronic components of the EV charging station 110. The technical unit 140 is made of two halves, a first technical half 141 and a second technical half 143. In some embodiments, the first technical half 141 and a second technical half 143 can be identical, or at least symmetrical. Such a configuration allows a user to choose which side of the EV charging station 110 is more convenient to use and provides redundancy in situations where one of the ports available for charging on the technical unit 140 is malfunctioning or otherwise unavailable. For example, the port on the first technical half 141 can already be occupied by a plug from a different vehicle, in which case the port on the second technical half 143 can be independently available to the user.

In contrast to currently available charging stations where the charging cable exists the charging station from a fixed location, the arrangement shown in FIG. 3 allows repositioning the charging cable from one charging port to another. That can be done by the user by pulling the connector 137 (see FIG. 2) to remove it from the charging port and then insert it in another charging port of the charging station. The charging port may be so relocated to better route the charging cable to the charging port of the vehicle parked adjacent the charging station.

The following description of first technical half 141 can likewise apply to the second technical half 143. However, in some embodiments only the first technical half 141 or the second technical half 143 can include a port. In further embodiments, three of more ports can be included in the technical unit 140.

The first technical half 141 includes an outer shell 145 which in turn fits around a component housing 149 that is sized and shaped to fit around the lamppost 105 and to the second, symmetric component housing 149 and be fastened thereto via suitable fasteners as is known in the art. The component housing 149 can be made of suitably durable materials, e.g., metal, or hard plastics. A station status LED light 150 and top cover 155 is attached at a top region of the component housing 149. The outer shell 145 also can be made of suitably durable materials, e.g., metal, or hard plastics. Various gaskets 160 ensure a watertight seal between the parts of the technical unit 140 and the lamppost 105.

The outer shell 145 has an aperture 147 that allows access to the charging port 170. The charging port 170 is further accessible through an aperture in the component housing 149 (positioned beneath the aperture 147 of the outer shell 145 when they are assembled). Also attached to the component housing 149 is a charging port door 171. The charging port door 171 can be motorized so that it can be automatically moved between a closed configuration where the charging port 170 is protected from the elements and an open configuration where the user can attach their charging plug. The LED light ring 175 can surround the charging port 170 and act to guide and provide information to the user (e.g., show that charger attachment has been correctly made by e.g., changing color or blinking in a pattern).

FIG. 4 shows further details of an exemplary attachment setup of between the technical unit 140 components and the lamppost 105 in a partial cutaway view. The back of the second technical half 143 is shown (not in detail) with the outer shell 145 and its aperture 147 visible. A protrusion on the outer shell 145 and a corresponding slot on the component housing 149 form an exemplary fastening arrangement 146 that quickly and easily attaches the outer shell 145 to the component housing 149.

Two gaskets 160 are visible, a top gasket 160A and a central gasket 160B. The gaskets also include the gasket 160C visible in FIG. 3 between the bottom of the technical unit 140 and the top of the base unit 125. The top gasket 160B (e.g., an O-ring) separates the top of the component housing 149 from the lamppost 105 at the station status LED light 150. The top gasket 160A is a watertight seal that prevents water and other fluids from entering into the technical unit 140. The top gasket 160A also fits circumferentially around the lamppost 105 and compresses as needed to allow the top of the component housing 149 to conform to the sides of the lamppost 105. To accommodate different lamppost form factors, the top gasket 106A can be thick (e.g., between 1 and 5 inches) to ensure a seal between the top of the technical unit 140 and different sizes of lampposts 105. To accommodate different possible lampposts 105, the thickness of the top gasket 106A can be constant or vary, e.g., have an inner shape that corresponds to a non-uniform outer surface of a given lamppost 105. The top gasket 106B can be made of suitable rubbers.

The central gasket 160B is placed around the lamppost 105 below the top gasket 160A. The central gasket 160 can be made of the same material (e.g., same type of rubber) or different material as the top gasket 160A. Like the top gasket 160A, the central gasket 160B is sized to fit circumferentially and snugly around the lamppost 105 and forms a seal e.g., by attaching at two halves or joining at a single joint. In the illustrated example, the central gasket 160B has a central extension 161 that protrudes from a central portion around the outer circumferences of the central gasket 160B. This central extension 161 is sized and shaped to mate with the inner surface of two hook support halves 165 that snap together around the central gasket 160B. The two hook support halves 165 provide a circumferential fastening slot 166 that engages with a hook 167 on the inner surface of the component housing 149. Via the fastening slot 166 formed by the support hook halves 165 and the hook 167, the two component housings 129 (and outer shells 145) can be affixed to the lamppost 105 atop the base unit 125. The various gaskets allow the EV charging station 110 to adapt and mount the technical unit 140 to any standard city lamppost 105 while easily accounting for different lamppost shapes.

The EV charging system 100 is designed to be resilient. All materials used can be vandalism safe and absorb potential impact to keep maintenance cost down as well as being weather-proof and built to last.

The electric vehicle charging system 100 uses a minimal invasive installation process that is quick and easy. This requires fewer structural engineering approvals to streamline installation. Installation can take a technician minimal time with no construction required. Only one NYCDOT standard 1¼″ hole is needed to connect the EV charging station 110 to the electric grid available via a lamppost 105 if access is made by creating a hole in the lamppost. Alternatively, the EV charging station 110 can access power via the existing lamppost access 107 on the lamppost base 109 leaving no mark at all.

The electric vehicle charging system 100 can include the different charging configurations that are used for charging EVs, Level 1, 2 and 3. Level 1 charging stations are 120-volt installations, which are standard household outlets that deliver power as from any wall to the vehicle's on-board charger. Charging times for Level 1 installations can be slow, with time from fully depleted to fully charged anywhere between 7 to more than 24 hours. Level 2 EV charging stations use a higher-output 208- to 240-volt installation. A 240-volt installation is similar to the ones used for oven or clothes dryers and delivers AC power from the wall to the EV's on-board charger with charging times that are much faster than with a Level 1 EV charging station, e.g., between 2-10 or more hours depending on the vehicle. Level 3 EV charging stations are 400-600 volts and are fast-charging installations that use very high voltage and can charge a fully depleted vehicle in about 30 minutes. They are expensive compared to Level 1 and 2 chargers.

Typically, the electric vehicle charging system 100 uses lampposts that provide Level 2 standard 240 power. The EV charging station 110 can also accommodate Level 2 low level 208-volt power or Level 1 120-volt configurations. An internal electric meter 199 within the technical unit 140 tracks electricity being used at a given charging port 170. The electricity being tracked by the electric meter 199 inside the unit could be isolated from the power from the luminaire on the lamppost 105 or could be reported together depending on the configuration desired by the municipality, utility company, or other agency managing the EV charging station 110.

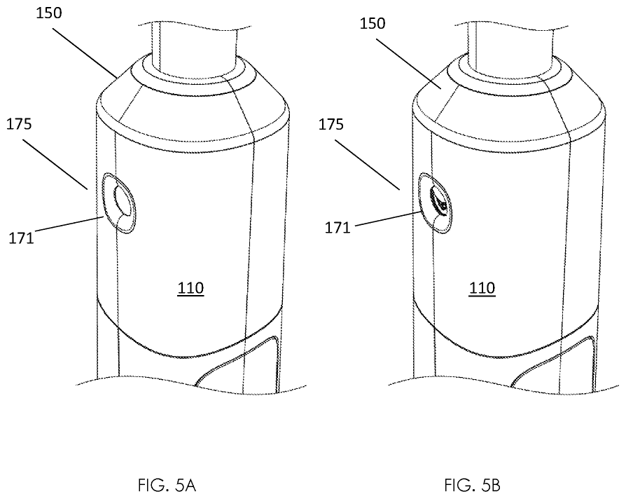

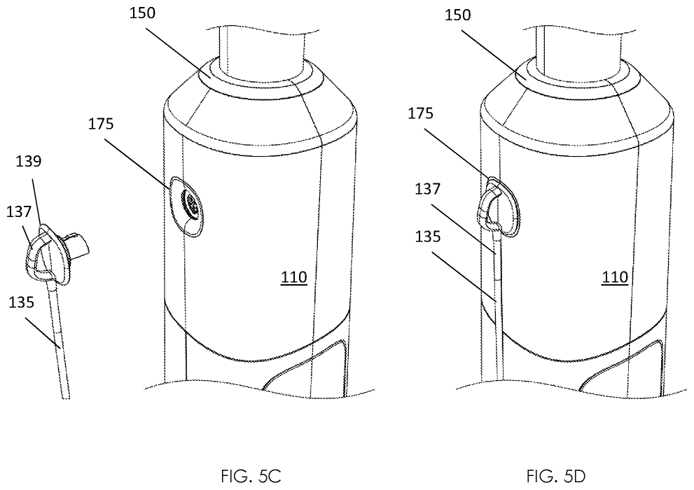

FIGS. 5A-5D shows different configurations assumed by the EV charging station 110 as it is deployed by a user. In FIG. 5A, the EV charging station 110 is in standby or available mode. This status is shown by the color or pattern of the station status LED light 150. The LED light ring 175 likewise shows that the charging port 170 is not occupied, and the charging port door 171 is in the closed position. It should be noted that a second charging port 170 (or in some instances, third or fourth charging port) can be located on the opposite side of the EV charging station 110. In such instances, the station status LED light 150 can indicate that the EV charging station 110 is still available for use. For example, the station status LED light 150 can have a different indication (e.g., color, pattern) that shows that at least one charging port 170 is available and at least one charging port 170 is in use. The station status LED light 150 can also change color indicating that maintenance is required, and that the charge is complete although the charging cable 135 remains plugged into the charging port 170. In some embodiments, the station status LED light 150 can be replaced by a screen that indicates the status information, or it can be absent from the unit.

At FIG. 5B, the user has activated the EV charging station (e.g., via the app 115 as described below). The motorized charging port door 171 is raised, revealing the plugs of the charging port 170. When the charging port door 171 is fully raised as in FIG. 5C the user can approach with the charging cable 135. In FIG. 5D, the user has successfully plugged the charging plug 137 of the charging cable 135 into the charging port 170. The LED light ring 175 can change color to indicate that the connection has been made. The station status LED light 150 can likewise change to indicate that a connection has been made at that particular charging port 170. In some embodiments, the charging port door 171 is manually raised, is permanently in the open position, or is absent from the technical unit 140.

In some examples, the charging port 170 is configured to use a charging plug 137 that is a pedestrian-safe charging socket, preferably, SAE J1772 J charging socket, also known as a J plug. The charging cable 135 is also designed such that the cable extends downwards against and nearly flat against the outer surface of the EV charging station 110 when the charging cable 135 is attached thereto. Various cable guides can keep the charging cable 135 in proximity to the outer surface of the EV charging station, helping to avoid pedestrians tripping over the cord. In some embodiments, the charging cable 135 is affixed to the charging port 170 using a magnetic attachment as discussed previously. The charging cable 135 can include a gasket cover 139 that seals the charging port 170 and avoids ingress of rain and snow.

In a possible variant, the charging port 170 may include a lock to prevent removal of charging plug 137 installed therein, such as to prevent theft or vandalism. In such example of implementation, the charging port 170 is unlocked to allow removal of the charging plug 137 inserted therein, or insertion of a charging plug, only when a successful user authentication has been performed which can be done wirelessly or otherwise. For instance, when a user wants to charge his or her vehicle, the user performs user authentication which includes a transaction to charge the consumption of the electrical energy to the user account, the charging port 170 unlocks the charging plug 137 allowing the user to remove the charging plug and reposition it in a different charging port of the charging station. Once the charging port 137 has been repositioned, the charging operation starts and the charging port 170 in which the charging plug 137 is now placed locks the plug into place and the plug cannot be removed. In some embodiments, an additional door on the system (e.g., on the technical unit 140 or the base unit 125) houses a station-specific charging cable 135 that unlocks through a particular user's mobile application 115.

To enable such selective locking or unlocking operation of the charging port 170, the charging port is provided with a locking mechanism that can acquire two operational states, that is, a locked state and an unlocked state. In the locked state, a charging plug 137 received in the charging port 170 cannot be removed or inserted. Removal or insertion of the charging plug 137 can be effected only when the charging port 170 is switched to the unlocked state.

The technical unit 140 has a control entity, which manages the operation of the charging port 170. That control entity, not shown in the drawings, is software based and is responsive to authentication of the user to lock or unlock the charging port 170. When a user is successfully authenticated the control entity will generate an unlock signal to the charging port 170 to place the charge port 170 in the unlocked state and then send a lock signal to place the charging port 170 in the locked state when the charging operation has begun or when the charging operation has ended, and the user has left.

### Cloud-Based Charge Management System 200

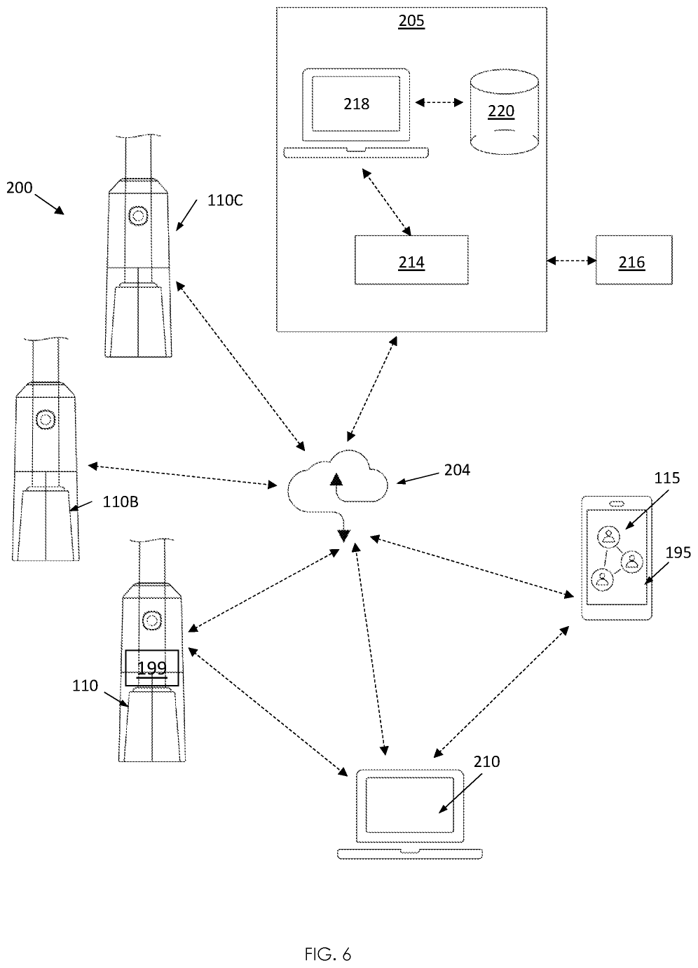

Referring to FIG. 6, the electric vehicle charging system 100 includes a cloud-based charge management system 200. The cloud-based charge management system 200 includes a cloud-based charge information manager (CIM) 205 that monitors and controls components of the electric vehicle charging system 100. The CIM 205 is in communication with the electric meter 199 that measures electricity within a given EV charging station 110 and provides insights and control to a user of the mobile application 115 and to a dashboard 210.

The cloud-based charge management system 200 allows information to be provided to and from a central location for managing multiple EV charging stations 110 that make up an entire distributed electric vehicle charging system. Information can be provided through a network 204 to exchange information with a collection of EV charging stations 110 (stations 110, 110B, 110C are illustrated but will be referred to collectively as 110) that all provide information to the CIM 205.

One or more technologies may be used for exchanging information among the CIM 205, the network 204 and EV charging stations 110. For example, wireless technology (capable of two-way communication such as Wi-Fi, 2G, 3G, 4G, 5G, or potential future 6G networks) may be incorporated into the EV charging stations 110 for exchanging information with the CIM 205. The CIM 205 can include a server 218 that is capable of being provided information from the network 204, and from a storage device 220 that is located at the CIM 205 and from external information sources 216. Along with providing and collecting information from the EV charging stations, the CIM 205 may be capable of processing information using a charge manager 214. The charge manager 214 can include algorithms with multiple functions, e.g., noting which EV charging stations 110 connected by the network 204 are being underutilized, which charging stations 110 are the most profitable, suggesting to users which charging stations 110 are likely to be available at a given time, etc. As such, the CIM 205 may be considered as being implemented as a cloud computing architecture in which its functionality is perceived by users (e.g., EV drivers) as a service.

Along with information being provided by the EV charging stations 110 (e.g., received from their electric meters 199, etc.), the CIM 205 may utilize data from other sources to improve and identify cost-saving opportunities, etc. For example, information sources 216 external to the CIM 205 may provide charge-related information such as the cost of electricity at the moment, or the predicted cost of electricity over the next week (based on an algorithm that provides historical usage trends). The charge manager 214, as part of the CIM 205, can dynamically monitor the EV charging stations 110 and this cost-related information to mitigate peak demand. For example, the CIM 205 may send notifications to users via the mobile application 115 alerting them that electricity prices will rise soon and advising them of the closest available EV charging stations 100 that will allow them to charge at the current lower electricity cost.

The network 204 sends data to and from the mobile application 115, which enables users to communicate with the EV charging station 110 via the mobile application 115 on a mobile device 195. The mobile application 115 includes discovery, status, and payment features, and manages charging reservations, proximity, pricing, status, payments, and billing. The mobile application 115 also dynamically converts KW charged into CO2e to provide drivers insights on the environmental impact compared to gas vehicle averages on a per charge, weekly, monthly, and annual basis. This can be calculated based on data for the energy mix on a national, State, or city level. The billing system also provides insights comparing prices to gas in the GPS surrounding area of the driver.

The mobile application 115 includes a map that provides visibility of real-time EV charging station 110 availability to users so as to maximize system utilization and efficiency for drivers. Drivers can reserve an EV charging station 110 to guarantee availability at specified times. When the driver parks their vehicle 120 in the spot at the reserved time, the mobile application 115 recognizes that the driver is parking for the charging event.

The driver's mobile device 195 unlocks the EV charging station 110 by opening the motorized charging port door 171 along providing light animation feedback via the LED light right 175 to start charging (as described with respect to FIGS. 5A-5D). Once the driver plugs the vehicle 120 in via the charging cable 135, charging starts automatically. The mobile application 115 can display a status screen that includes estimates of full charge time remaining plus cost incurred based on electricity consumed.

Via the mobile application 115, the driver can receive notifications pertaining to the time remaining for the particular charging event. For example, a notification can appear on the mobile application 115 when 30 minutes remain, 15 minutes remain, or 5 minutes remain for the particular charging event. Upon completing charging, the driver unplugs the charging cable 135 and drives away. Billing details are stored in the mobile application 115 and emailed to the driver via the cloud-based charge management system 200. The billing details can also be accessed by third-party mobile applications that interface with the cloud-based charge management system 200. The information available to the user can include an impact section describing financial savings and environmental benefits. In some instances, “impact badges” can be shared among users of the electrical vehicle charging system 100 to build community and encourage use. Other community- and awareness-building features include indicators of economic and environmental impact that can be shared across digital platforms including all mobile messaging and social media channels.

When a driver opens the mobile application 115, they can create an account with credit card details and by authenticating an account with an existing mobile payment platform. The next screen confirms a welcome kit with a charging cable 135 that will be mailed to the user. Once the welcome kit arrives, the driver enters a code to link their personal charging cable 135 to the mobile application 115. Upon turning on location services, the mobile application 115 displays a digital map with EV charging station 110 locations.

When a driver taps an icon representing an EV charging station 110 while a car is charging, the time remaining is displayed. Drivers can make a reservation at an available EV charging station 110. Once confirmed, they are prompted to turn on notifications. The driver parks their car in the spot at the reserved time. The mobile application 115 recognizes that the driver is parking for the first charging event and shows how to get started.

The driver holds their phone up to the EV charging station 110. This starts light animation (e.g., the LED light ring 175 and/or the station status LED light 150) and opens the motorized charging port door 171. Once the driver plugs their charging cable 135 into the charging port 170, charging starts automatically. A status screen on the mobile application 115 estimates full charge time remaining plus cost incurred based on electricity consumed.

In some instances, the mobile application 115 enables drivers to select Level 1 charging in the mobile application 115 for a lower price point.

The CIM 205 measures and analyzes real-time data from charging events and can display such data on the dashboard 210. The dashboard 210 can be viewed on the same mobile device 195 as hosts the mobile application 115 or can be shown on a different device. The dashboard 210 allows policy and business stakeholders to establish benchmarks to forecast demand while optimizing grid performance. Charging station utilization will inform future deployment.

In some embodiments, the mobile application 115 can be hosted on an in-car touchscreen map to start charging events. In additional embodiments, the functions of mobile application 115 can be integrated into car manufacturer mobile applications. For instance, a car manufacturer may want dashboard visibility on all vehicles the company has manufactured that are using the charging network. In some embodiments, charging station locations can be viewed in third-party mobile and web applications via the open charging point protocol.

The electric vehicle charging system 100 includes a throttle sensor that enables network operators to adjust electricity distribution via the charge management system to maximize grid stability.

In one example implementation, the electric vehicle charging system 100 system has a SAE International North American SAE J1772 J plug EV connector. The electric vehicle charging systems disclosed herein can be adapted for use with many different types of lampposts. As one example, the electric vehicle charging system 100 retrofit system can be coupled with the Standard Octagonal NYC streetlight. This lamppost has a tapered steel pole with LED Cobra Head lamp with 18- and 30-foot height models. Also, the electric vehicle charging system can be adapted for use with the Standard Davit NYC streetlight that has a curved pole with 30- and 16-foot configurations. Both have a 22″ steel base cover.

In some embodiments, the EV charging station 110 can include Wi-Fi router connectivity to provide a strong electric vehicle signal connection. Such a charging station configuration enables drivers to download larger data packets while charging the car, of particular use to city drivers who park on streets and who lack internet connectivity to complete EV software updates. The option to initiate a software update via the EV charging station could be selected via the mobile application 115 (accessible on a smart phone or in-car system).

In some embodiments, the vehicle 120 itself can include an internal metering system to track kilowatts of electricity consumed during a charging session. In this configuration, the EV charging station 110 may or may not have an internal physical meter (e.g., electric meter 199) and the vehicle's metering system would be the primary source to provide a dataset via the driver's authenticated mobile device 195 to the cloud-based charge management system 200. These data could be sent exchanged with utilities and/or OEM-owned charge management systems.

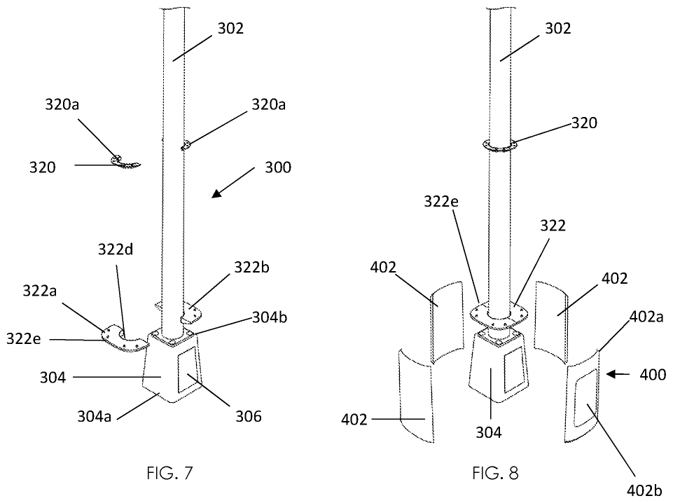

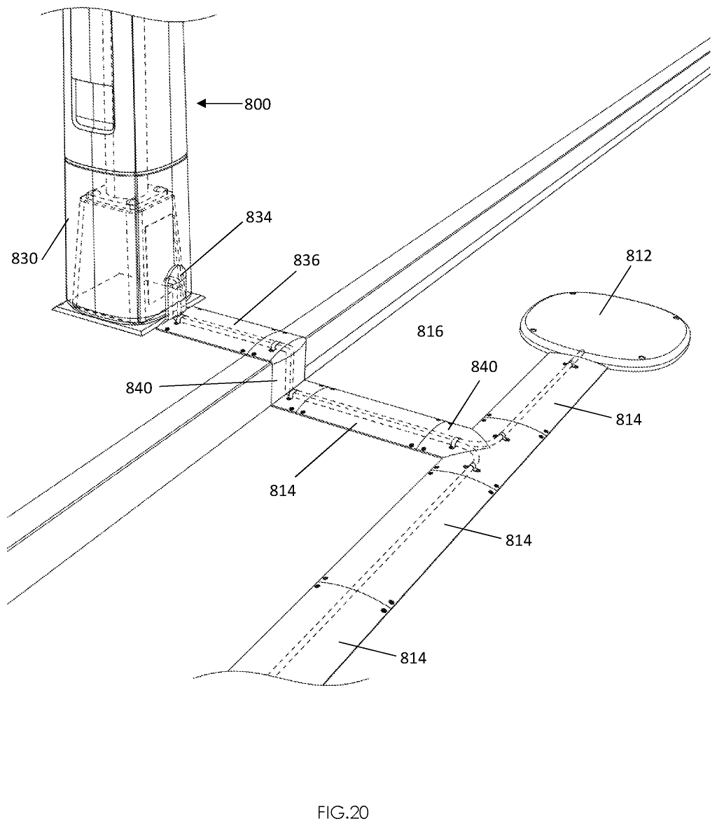

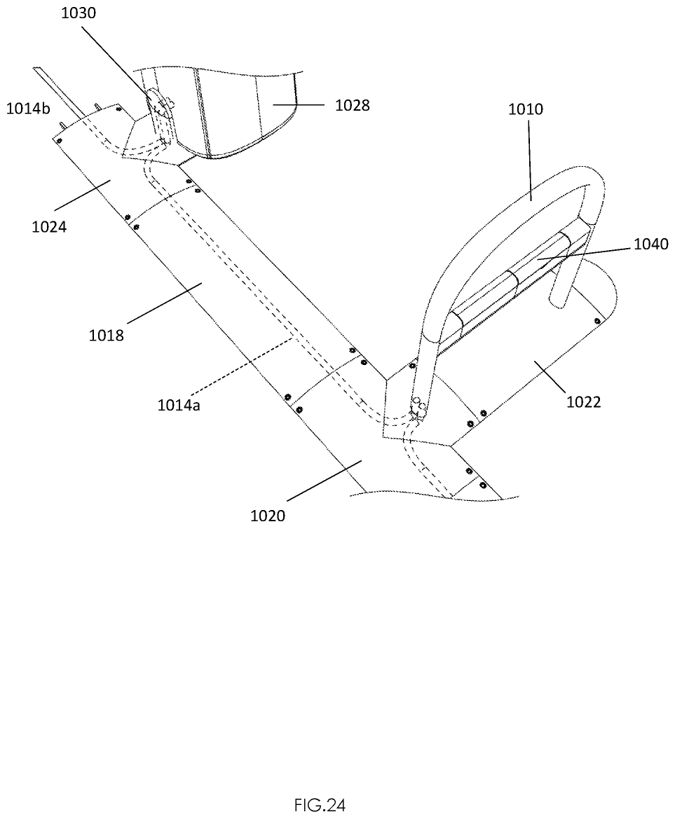

FIGS. 7-25 illustrate other embodiments. In these embodiments, a station, preferably comprises four individual modules, and thus can be considered a quad module configuration.

In FIGS. 7-14, the described station comprises a charging system, with a function unit in the form of a charging station 500 at least one of the modules of which has a charging function capability. In this embodiment, there are four charging function capable modules. However, as noted above, it can easily be understood that the station can comprise four modules only one or some of which have a charging function capability, with the remaining modules being dummy or filler modules, or modules having a non-charging function capability or a communications capability. Also, in some applications, the number of modules can be more than four should the diameter of the pole surrounded by the modules be sufficiently large, or two or three, depending upon the dimensions of the modules. Further, two or more, but necessarily all, of the modules may be modular. However, from a practical point of view, the number of modules with a charging function capability preferably is four to provide charging function capability to four adjacent parking lot parking spots (as described below), or preferably two to provide charging capability to two adjacent curbside parking spots as described in the prior embodiments.

Also, as explained below, in contrast to the “bring your own cable” embodiment described above in connection with FIGS. 1-6, in the embodiments described next, the charging cable, preferably a retracting cable, is contained within a module having charging function capability and can be pulled out by a user.

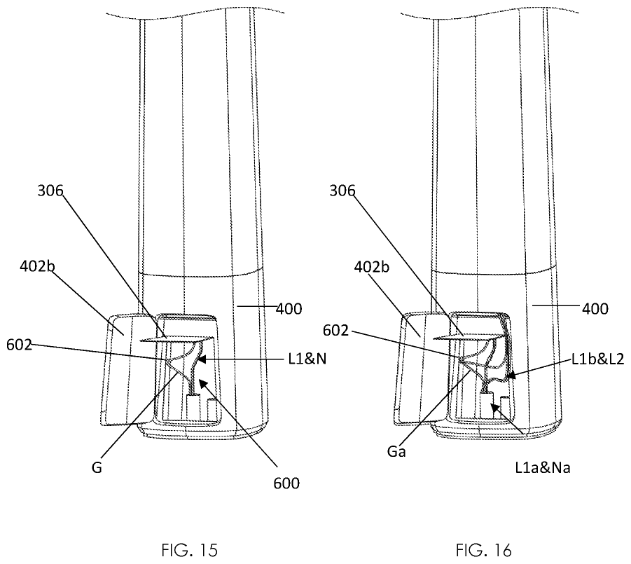

As illustrated, a lamppost 300 typically includes a pole 302 and base 304 with an access door 306. The access door 306 provides access to the lamppost wiring providing or delivering electrical power to the lamp 306. The wiring is shown in FIGS. 15 and 16 and discussed further below.

The base unit 304 is illustrated as a truncated pyramid, but other shapes are possible. The truncated pyramid shape is merely a typical shape given the greater stability it can impart due to the bottom, pavement-facing, edge 304a being of perimeter that is greater that of the top, upward-facing edge 304b.

As illustrated, preferably, an upper bracket or collar 320 and a lower bracket or collar 322 are attached to the pole 302 of the lamppost 300. The upper bracket 320 preferably is comprised of two halves 320a and 320b that are joined together around pole 302, with the two halves 320a and 320b secured to each other by any suitable means such as interlocking parts or bolts and nuts with the bolts extending through unillustrated mating flanges. Similarly, the lower bracket 322 preferably is comprised of two halves 322a and 322b that are joined together about the pole 302, with the two halves 320a and 320b secured to each other by any suitable means such as interlocking parts or bolts and nuts with the bolts extending through unillustrated mating flanges. The lower bracket 322 preferably is located at or just above the upper surface of the base unit 304, and at a distance appropriate for securing thereto panels of charging station base unit 400 to be described below.

Each of the upper bracket 320 and the lower bracket 322 preferably are ring brackets, each with an inner periphery, 320d and 322d, respectively, that conforms to the outer diameter and shape of the pole 302. In this embodiment, the inner peripheries 320d and 322d are circular. However, the inner peripheries can be any suitable shape conforming to a lamp pole such as polygonal, e.g., rectangular, pentagonal, or hexagonal. Preferably, the lower bracket 322 has a mostly rectangular outer periphery 322e with rounded corners, to match the shape of the upper surface of the base unit 304. However, other shapes can be used, e.g., brackets with circular outer peripheries, depending on how the charging modules, described below are designed to engage with the brackets. Additionally, preferably, each of brackets 320 and 322 also includes a gasket (preferably made of rubber) surrounding the pole 302 to combat moisture ingress

As illustrated in FIG. 8, a base unit 400 preferably is comprised of four portions or panels 402 (mostly referred to herein as panels), that when assembled together surround the lamppost base unit 304, each portion or panel 402 facing a respective face or side of the base unit 304. One panel 402a, also include an access door 402b that provides access to the access door 306, so the panel 402a is placed facing the access door 306. The panels preferably are rectangular in front or rear view and are slightly curvilinear in horizontal cross section to impart a degree of roundedness to the assemble base unit 400. However, panels with other horizontal cross section shapes can also be employed. The panels can be made of any suitable material such a concrete, fiberglass, cast iron, plastic, or steel, to name a few.

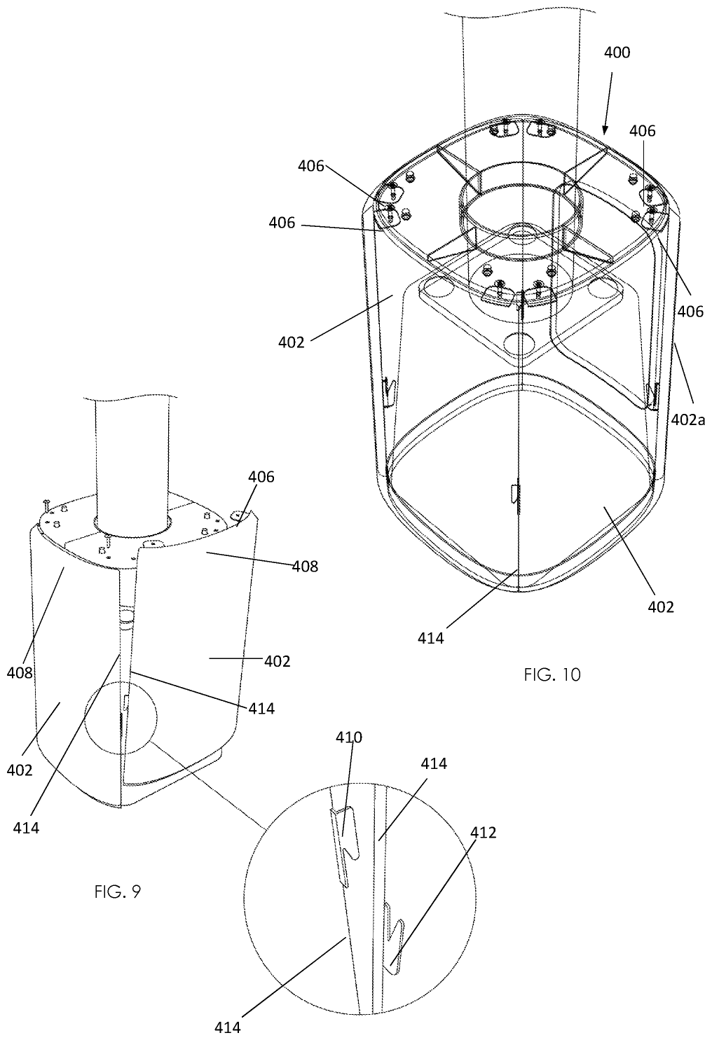

The base unit panels 402 are secured to the lower bracket 322 in any of a number of suitable ways. The panels 402 can be bolted or screwed to the lower bracket 322, or can have a lip that engages with a catch at or near the outer periphery 322b of the lower bracket 322. In FIG. 9, the panels 402 are shown to have in-molded tabs 406 at top edges 408 that are secured to the lower bracket 322 by means of screws or bolts 410 that extend downward through suitable holes in the bracket 322 and the tabs 406. The tabs 406 are thus secured to an underside of the lower bracket 322.

The panels 402 also preferably engage with and are secured to each other along lateral edges 414 of the panels 402 via suitable engagement means such as mortise and tenon arrangements, latching arrangements, or bolting arrangements. As one example, the panels can have interiorly extending tabs (preferably in-molded) that align when the panels are assembled, and the panels 402 can be secured together by bolts extending through aligned holes in the tabs. It can be appreciated that the panel 402a with the access door 402b would be the last panel to be installed so as to provide access to the engagement means between it and the adjacent two panels 402, if securing the panels 402 requires accessing the interior of the charging stating base unit 400. In FIGS. 9 and 10 The panels 402 are shown to also include in-molded mating hook tabs 410 and 412 that engage with each other to secure together lateral edges of the panels 402. In FIG. 9 the panels 402 are shown during assembly and in solid, while in FIG. 10, the charging module base unit 400 is shown in transparent view to enable better appreciation of an assemble base unit 400.

As can be seen, the tabs 410 are hooked with an engaging recess 410a in the downward facing edge 410b while the tabs 412 are hooked with an engaging recess 412a in the upward facing edge 412b. During assembly, adjacent panels 402 are slide relative to each other until the engaging recesses 410a and 412a engage each other and the tabs 410 and 412 become hooked together. As can be appreciated, one set of panels 402 on opposite sides of the base unit 400 will have only tabs 410 while the other set of panels 402 on the orthogonal opposite sides of the base unit 400 will have only tabs 412.

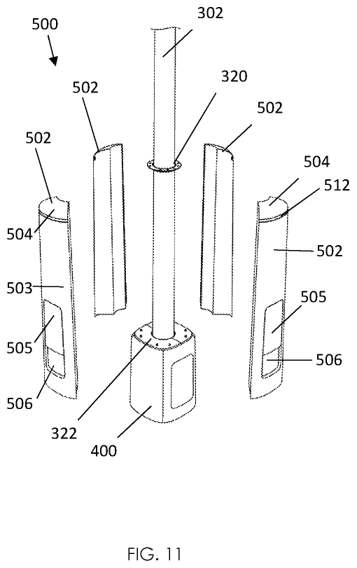

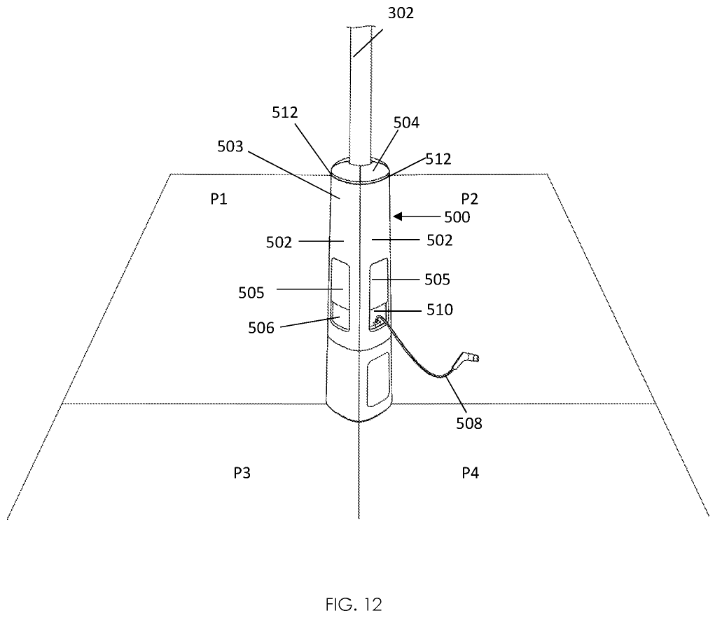

As illustrated in FIGS. 11 and 12, the charging system preferably includes a function unit 500 comprising a plurality of, preferably four (4), modules 502 that, when assembled together, surround the pole 302 and are secured to the upper bracket 320 and supported on the lower bracket 322. It can be appreciated that the modules 502 can all have a charging function capability or one or more can have no function capability, but which provide support to the other modules and aesthetics to the charging station. Further, one or more of the modules 502 can non-charging function capability or a communications function capability. As described below, modules 502 having non-charging function capability or no function capability may include less or different physical features than the modules having a charging function capability.

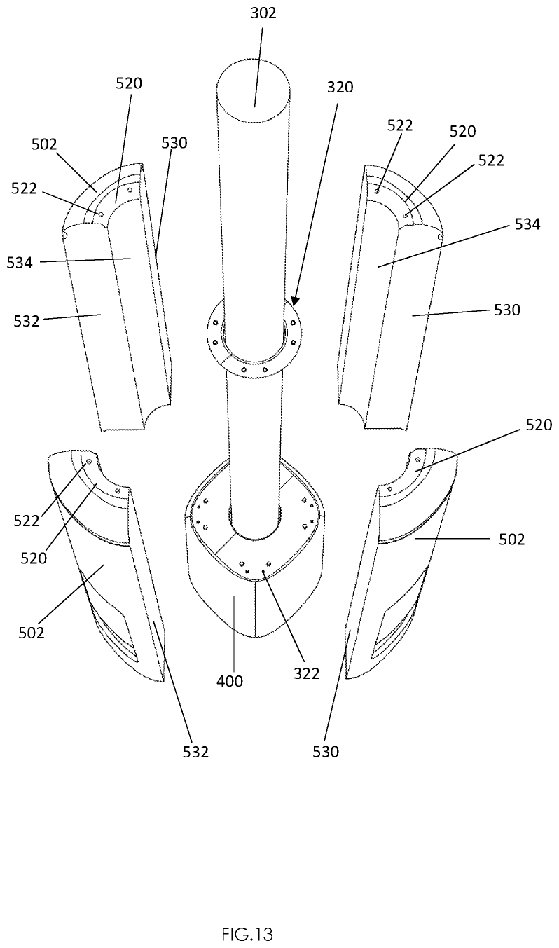

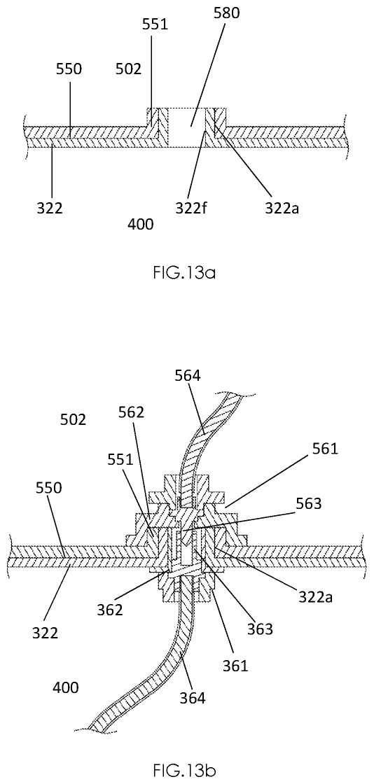

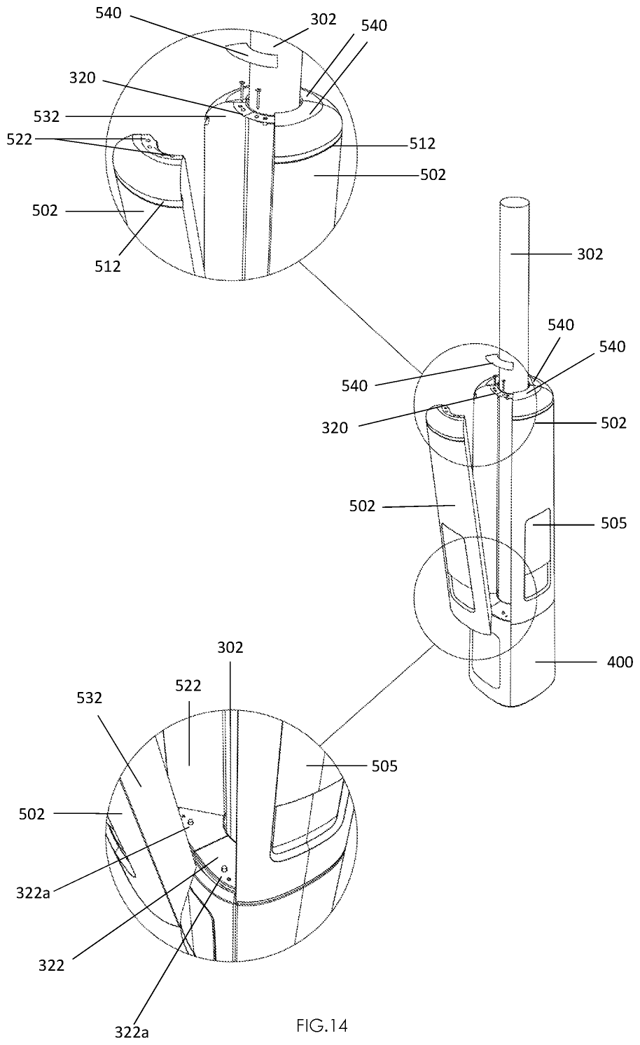

In FIGS. 11 and 12, each module 502 includes a vertical outer surface 503 that extends substantially parallel to the pole 302 and a quarter ring top 504. The top 504 and the interior sides of a module 502 are described in greater detail below. However, it can be appreciated that preferably the outer surface 503 is curved in conformity with the outer perimeter of the pole 302 and the top 504 also has a curved surface thereby imparting smooth and curvilinear exteriors to the modules 502 to contribute to the shedding of rain, sleet, and snow while providing pleasing aesthetics. A preferred attachment arrangement is described below in connection with FIGS. 13 and 14.

Other arrangements for securing the base unit panels 402 and the charging station modules 502 to the lower bracket 322 and the upper bracket 320, respectively, and to each other are described above in connection with FIGS. 2 and 3 and can be combined or substituted with those just described as may be suitable or desirable.

In FIGS. 11 and 12, each charging functional capable module 502 preferably includes a display 505 that preferably is comprised of an and electronic display, preferably an e-ink display, with electronic display behind a pane of bullet proof weather sealed glass. The pane of glass would inhibit, if not prohibit, physical access to the electronic display. Further the pane of glass would protect against weather effects and dirt and grime.

Each charging function capable module 502 also preferably includes a lockable door 506 behind which is stored a ratcheting retractable charging cable 508 accommodated within a charging port 510. The door 506 preferably is motorized, but can be a manually, electronically lockable door. Ratcheting cable retractors are well known and utilized for many different types of power cables. Ratcheting retractors are also employed in many other areas such as seatbelts and fuel pump hoses. The ratcheting retractor in this situation would be sufficiently robust and strong to withstand a large number of extractions and retractions of a charging cable while maintain a strong spring loading for retraction. The mechanism by which the cable is retracted could also be electrically controlled or motorized, and the aforementioned embodiment is one such non-motorized method. The charging cable 508 can conform to any of the well-known SAE J1772, SAE J1772/Combined Charging System, or IEC 62196 vehicle interface standards.

The motorized door 506 preferably is controlled by a local controller system that communicates with the CIM 205 via the network 204, both described above, or a suitable controller app on a handheld device, e.g., a cellular telephone. Each door 506 preferably is associated with a respective electronically readable code, e.g., a QR code, that can be imaged and read by an app on the handheld device or the CIM 205 after transmission of the image by the handheld device to the CIM 205.

Preferably, the motorized door 506 is supported on tracks so that when the door is opened, the door 506 will rise vertically and slide in behind or over the electronic display 505, thereby giving access to the retractable charging cable. Following a charging event, after the charging cable retracted into the charging station module, the door 506 is activated into its closed position by the local controller. Of course, safety is taken into consideration and closing of the door may be delayed sufficiently to allow ample time for a user to remove their hand from the path of the closing door.

As also illustrated in FIGS. 11 and 12, each module 502 or at least each charging function capable module 502 preferably includes a light 512, preferably comprised of one or more light emitting diodes (LEDs) that can be turned on to indicate when the module is being used in a charging action (as described above) or to provide visibility or to impart ornamentation to the charging station 500. The light 512 preferably is positioned at an outer edge of the vertical surface 505. However, it can be appreciated that other positions, such as somewhere along the vertical surface 505 are also acceptable.

As mentioned above, it can be appreciated that modules lacking a charging function capability might not include all of the physical characteristics and features of the charging function capable modules. For example, non-charging function capable module or no function capable module need not include a motorized door, a charging cable, an electronic display, or even a transparent pane. Preferably, such a non-charging function capable module or no function capable module could have a smooth outer surface without any openings by would still have a similar appearance as the charging function capable modules to provide an consistent ornamental appearance.

As further illustrated in FIG. 12, a charging system can be positioned at the common corner(s) of four adjacent parking spots: parking spot P1, parking spot P2, parking spot P3, and parking spot P4. The function unit or charging station 500 is oriented so that each module 502 is facing a respective parking spot. However, the orientation can be different given sufficient long retractable charging cables. It can be appreciated that for fewer adjacent parking spots, fewer charging function capable modules are needed. Thus, for each nonexistent parking spot, preferably a dummy or filler module, i.e., a no function capable module replaces a charging function module.

Again, for curbside placement of a charging system, the charging station preferably includes only two oppositely facing charging function capable modules 502 to provide charging capabilities to adjacent curbside parking spots, or perhaps only a single charging-capable charging station module facing away from the curb.

In FIGS. 13 and 14, an assembly of function unit 500 and the attachment of the modules 502 to the upper bracket 320 and the lower bracket 322 is shown in greater detail. For that purpose, each module 502 includes a top end 520 that becomes secured to the upper bracket and a bottom end that becomes secured to the lower bracket 322. As can be seen in FIG. 13, in addition to the outer vertical surface 503, each module 502 preferably includes three interior sides or surfaces 530, 532, and 534. Side 534 is between sides 530 and 532 and is curved so as to mate with a round perimeter of the pole 302. Sides 530 and 532 are flat or planar and define a 90-degree angle with respect to each other so that four modules 502 will fit together about a lamppost pole. Of course, in situations where there are two modules or three modules or more than four modules, the angle defined by the sides 530 and 532 will be different. Additionally, the side 534 can be of whatever shape appropriately matches the pole surface it faces. For example, if the pole surface the side 534 faces is flat, then the side 534 can be planar.

The top 520 preferably includes two concavities in the form of holes or detents 522 for receiving convexities, e.g., spring loaded balls, pins, or other protrusions used to secure the module 502 against lateral movement with respect to the upper bracket 320. The concavities 522 can be in-molded into the top end 520 or be provided as bar or bracket attached to or in-molded into the top end 520. As best seen in FIG. 14, each module 502 preferably also is secured by security bolts or screws 523 extending through holes in the upper bracket 320 and into suitable holes in the top end 520.

In FIGS. 13a and 13b the bottom end 550 of each module 502 also preferably includes concavities in the form of openings or detents similar to the concavities 522. In FIG. 13a a representative concavity 551 is shown. These concavities 551 could be hollow or having one or more openings, so as to provide an aperture 580 between the interior of the base unit 400 and the interior of the module 502. The bottom bracket 322 then preferably includes two or more matching convexities in the form of spring-loaded balls, pins, or other protrusions 322a such as bosses, that can be hollow or having one or more matching openings 322f with the concavities 551 in the bottom end 550 of each module 502. The pairs of these concavities and convexities can also be used to provide electrical connections as shown in FIG. 13b, by the forming of a coupled set of electrical contacts which comprise the convexities and concavities such that protrusion 322a is itself or contains a convex body connector 361 and mates with a complementary concave connector 561 on the bottom end 550 of a module 502. A lower bracket connector 361 comprises some insulating mechanical coupling 362, a an electrically conductive contact or ferrule 363 in or upon which a conducting element or wire 364 may be crimped, soldered, or otherwise electrically and mechanically attached. A module connector 561 comprises some insulating mechanical coupling 562, an electrically conductive contact or ferrule 563 in or upon which a conducting element or wire 564 may be crimped, soldered, or otherwise electrically and mechanically attached. The lower bracket connector 361 and module connector 561 are complementary such that they may form a closed circuit when the lower bracket 320 convex protrusions 322a are mated to the concavities 551 in the bottom end 550 of a module 502. Although not shown, the lower bracket 320 protrusions 322a in either instance that it may contain an opening 322f or comprise a connector 361 that may also be spring loaded in methods known to those familiar in the art. As can be appreciated, in a typical assembly, given the use of spring-loaded convexities, a module can be first secured to the brackets 320 and 322 by sliding it into place, and then secured by the security bolts/screws 523.

Alternatively, the bracket 320, the bracket 322, or both of the brackets 320 and 322 can include concavities for receipt of spring-loaded convexities provided at the top end, bottom end, or both the top end and the bottom end of a module 502. In one embodiment, the convexities 322a of the lower bracket or the bottom end of the module 502 can be fixed bosses. In this case the bottom end of the module is first engaged with the lower bracket 322 and then tilted into position with respect to the upper bracket 320.

After the modules 502 are secured in place relative to the brackets 320 and 322, the bracket 320 is concealed by means of quarter-ring shaped (for circular poles) cap pieces 540. Preferably, each module 502 has a respective cap piece 540 that is snap fit into place thereby to conceal the upper bracket 320.

In FIGS. 15 and 16, the supply of power to the modules 502 is illustrated. In FIG. 13, the typical wiring of a lamppost is illustrated. It can be seen that power is provided to the lamp by means of a wiring bundle 600 comprising a hot wire L1 and a neutral return N, which also are connected to contacts in a distribution box (not shown). A ground wire G which is connected to a grounding nut or bolt 602 in the base of the lamppost, as required by National Fire Prevention Association (NFPA) code 70, also is included.

In accordance with principles herein, preferably separate wiring is used to supply power to the modules 50s. In order to do so, preferably, the existing wiring 602 is used as a pull-through guide for new wiring. To that end the existing wires 602 will be cut within the lamppost base 304, and the existing wiring 602 will be securely attached to a new wiring bundle 604 either at its distribution box end or its lamppost base end. The old wiring 602 is then used to pull the new wiring bundle 604 through a conduit.

As can be seen in FIG. 16, the new wiring bundle 604 includes 5 wires, a line L1a and neutral line Na with are spliced to the L1 and N wires of the remaining existing lamp wiring 600, a ground wire Ga which is connected to the grounding bolt or nut 602 in the lamppost base unit 300 as well as to the modules 502 and wiring lines L1b and L2 which also are connected to the modules.

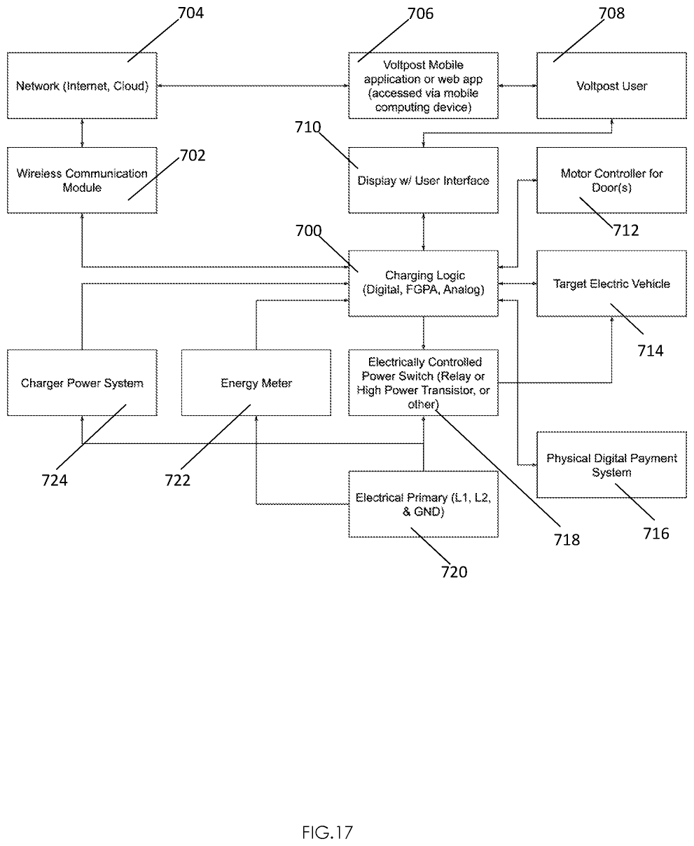

In FIG. 17 there is illustrated a block diagram of software and/or circuitry of an operating or control system or scheme in accordance with which a charging station system is controlled and operated, preferably with one such systems per module. In the illustrated system, a controller 700 containing the charging logic, in the form of computer executable instructions, firmware, field programable arrays, or any combination of them, is in bidirectional communication with a communications module 702 (preferably a wireless communication module), an electronic display 710 (which is the electronic display of the display 505), a motor controller 712 of a motorized door or motorized doors, a target electric vehicle 714 (when connected for charging), a physical digital payment system 716, and an electrically controlled power switch 718. In turn, the communication module 702 is in bidirectional communication with a network 704 such as the Internet or a cloud. The network 704 is in bidirectional communication with an interactive application 706 such as a mobile application or a web application. A user 708 interacts with the application 706 in a bidirectional way (i.e., receives information and inputs information). The user 708 also can interact with the electronic display 710 in a bidirectional way. And electrical energy is supplied via an electrical wiring 720 comprising the primary lines L1 and L2 and a ground wire GND that have been fished to the lamppost. The power from the wiring 720 is communicated to the energy meter 722 and the switch 718.

The controller 700 can comprise any suitable computer processor-based controller with one or more data processors capable of executing processor readable and executable instructions or code and non-transient memory for storing such instructions or code. Alternatively, the controller 700 can comprise field programmable gate arrays or the like that effectively serve the same function. Further, the controller 700 can comprise analog logic and/or machine logic devices.

The communications module 702 can be any well-known module that uses a wireless communication protocol or a wired protocol. In this embodiment the communications preferably are via a wireless communication protocol. Additionally, the communications module 702 may be physically distinct from the controller 700 or integrated with the controller 700, both of which types of configurations are well known. The communications module 702 in turn communicates with a network (Internet or cloud servers) via a wireless communications provider, e.g., the cellular transmitters and receivers of cellular towers or other well-known access points. The controller 700 can employ any of the known electric vehicle charging station protocols such as the Open Charge Point Protocol (OCPP) mentioned above to exchange information about the charging station 500 and back-office management systems. There are a number of other different known open protocols that can be employed depending on the amount and type of information to be exchanged.

A device of a user 708, such a mobile device or computer 706 can execute an installed application or access a web application that also communicates via the network with the communications module 702, and then with the controller 700. Via the installed application or the web application, a user can activate a charging station module to enable charging of a vehicle, to make payments, and otherwise engage with the charging station, e.g., as described in the other embodiments.

The controller 700 provides information to the user 708 via the display 710, e.g., by displaying information about the status of the charging station module, amount of charging, cost of charging incurred, instructions for activating the motorized door, instructions for use of the charging station/function unit module, etc. The controller 700 can also communicate other information such as advertisements, news, weather, specials, etc. to the display, much like occurs at many gasoline service stations currently do.

The controller 700 communicates with the motorized door motor controller 712 in response to activation by the user in accordance with the processor instructions or code executed by the one or more data processors. The controller 700 will communicate open and close or unlock and lock commands, as well as receive feedback as to the open/closed status of the associate door, or even the status of the progress of the opening or closing or unlocking or locking of the door.

The controller 700 also can communicate with a target electric vehicle while the vehicle is connected to the charging cable. For the purpose, the International Standard Organization provides protocol ISO 15118 that defines such interactive communications and the interface.

The controller 700 can also communicate with a physical payment system 716 embedded in the module 502. Such as system can include a credit card reader such as presently are available on the pumps of retail fuel stations.

The controller 700 communicates with a power switch 718 to turn the charging function on and off. The power switch 718 is configured to pass or block electrical power from the primary power source 720 to the target electric vehicle 714. The primary power source 720 comprises the incoming power line bundle 604 described in connection with FIGS. 15 and 16. The power switch 718 preferably is electrically controlled and comprises a relay or a high-power transistor. However, digitally controlled switching systems can also be employed.

The controller 700 preferably receives energy consumption data from an electrical energy meter which is coupled between the control 700 and the primary power source 720.

The controller 700 may also communicate with a meter 708 operatively connected to measure the amount of power consumed in a charging operation so as to enable a calculation of charges for the charging operation. Alternatively, the processor can simply determine usage and charges based on timing of the charging activity. Preferably, the controller 700 is capable of adapting to variations in the cost of the electricity used to power the charging station module and/or used for changing operations.

Finally, the controller 700 is coupled to receive conditioned power from a charger power system 724. The conditioned power can include down-transformed and AC/DC converted power suitable for use by a digital controller 700. The charger power system 724 can be connected to the incoming primary electrical power 720 for that purpose.

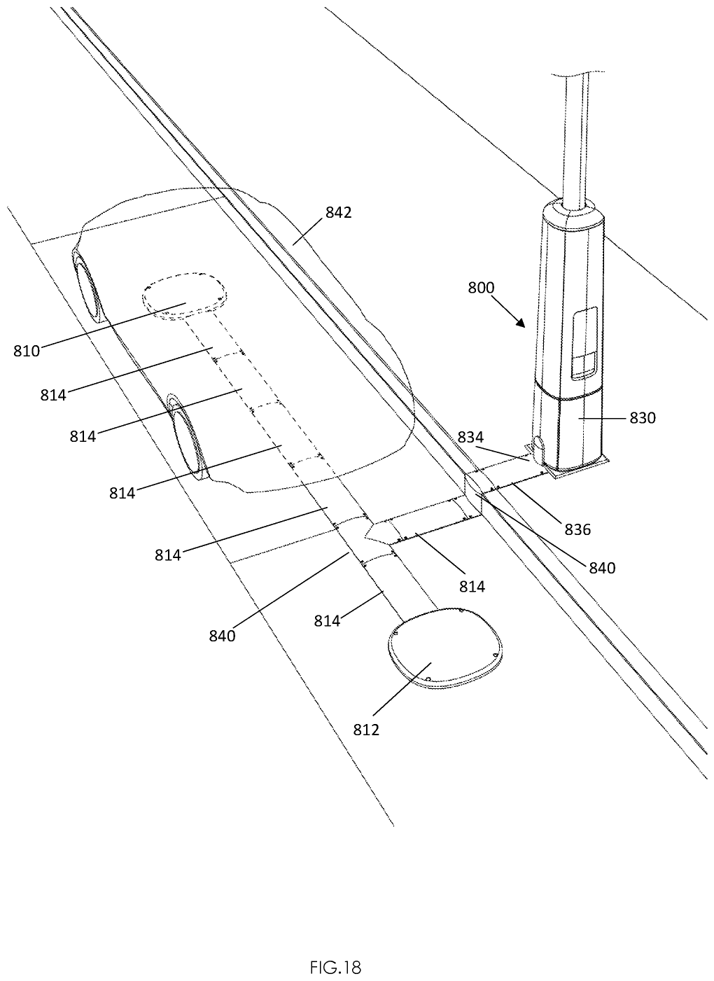

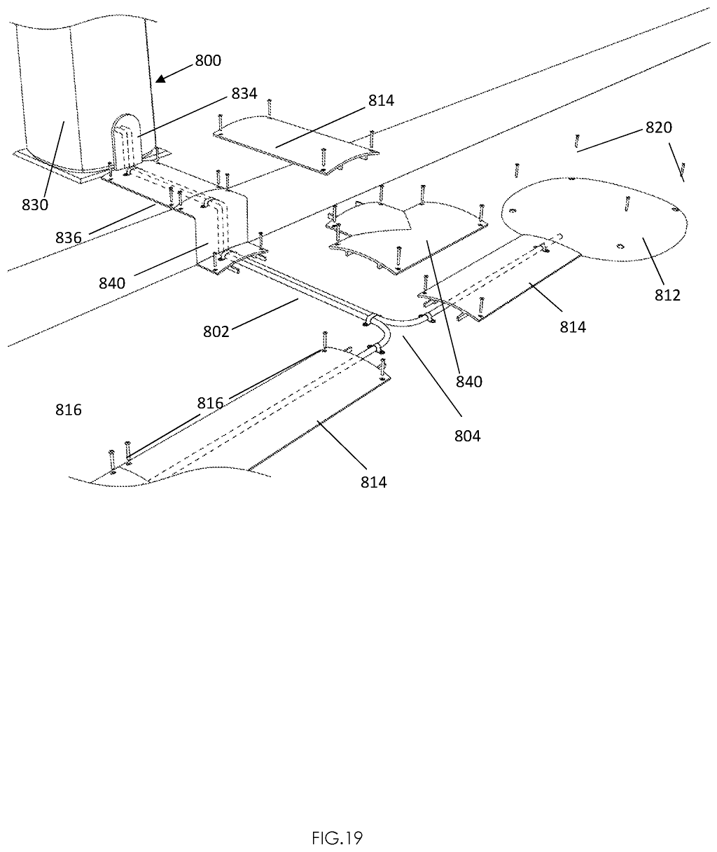

FIGS. 18-20 illustrate a charging system with a charging station/function unit 800 that is similar to the function unit 500, but which is adapted for wireless charging of a vehicle using ground-based, charging coils. In this embodiment, the charging system includes power cables 802 and 804 the energization of which is controlled by the charging station 800. Of course, only one or more than two wireless charging coils can be configured as desired. This embodiment is but one example of a wireless charging system.

Today's wireless charging technologies have efficiencies above 90 percent, which is very close to those of plug-in systems. These systems employ induction coupling technologies to transfer energy with inductively magnetically coupled coils: a primary coil associated with a source of electrical power, and a secondary coil associated with an electric vehicle.

Care must be taken to minimize fields outside the vehicle footprint, to reduce the risk of exposure to humans. Fields are shaped by the types of coils involved and controlled to remove potential interference or exposure to humans. Technologies are known to provide for foreign object detection and living object protection. Foreign object detection technologies can identify the presence of a metallic between the primary coil housed in a primary pad, and the secondary coil housed in a vehicle pad. Even small metallic objects can cause the primary coil to heat up and thus pose a burn risk during power transfer. Living object detection technologies can identify the presence of humans or animals close to the power transfer system and can be helpful in those situations where the fields exceed acceptable levels.

The automotive industry is working on standardization of wireless power transfer standards and protocols. Standards such as SAE J2954 include provisions for safety and electromagnetic limits, testing, and efficiency and interoperability.

In FIGS. 18-20, two primary pads 810 and 812 are provided secured to a road within adjacent curbside parking spaces. Power cable 804 is connected to the primary pad 812 while power cable 802 is connected to primary pad 810. The cables 802 and 804 are suitably connected to the controller of the charging station 800. Foreign and living object detection components can be present in the primary pads or in the second pad of a vehicle, depending upon the technologies employed.

Preferably, the power cables are covered and protected by a set of cover plates 814 that are firmly secured to the pavement 816 of the parking spots by means of bolts or screws 818. Similarly, the primary pads 810 and 812 are firmly secured to the pavement by means of bolts or screws 820. The cover plates 814 preferably have a curvature so that while the thickness of the cables 802 and 804 can be accommodated, the edges of the cover plates 814 are flush with the pavement 816. Similarly, the edges or peripheries of the primary pads 810 and 812 are secured flush to the pavement 816.

It can be appreciated that the cables and primary pads could be buried under the pavement or placed in recesses so as to be flush with a top surface of the pavement, in this embodiment, the wireless system can be easily installed without have to cut into the pavement, and thus risk providing a weakness in the pavement. This could be especially true in norther climates where ingress of freezing and thawing liquids tends to destroy pavement by expanding and contracting within crevices and cracks in the pavement. Additionally, this solution avoids any need for trenching and construction and the permitting required for them.

As can also be seen, the base unit 830 of the charge station/function unit 800 includes a suitable opening in a panel thereof via which the power cables 802 and 804 exit the base unit 830. A plate 834, which preferably is a tab or extension of a sidewalk cover plate 836 covers the opening when the sidewalk cover plate 836 is firmly secured to the sidewalk by means of bolts or screws 838. A t-shaped cover plate 840 is used to cover and protect the cable at the point where the power cables diverge and extend to their respective primary pads.

In most, if not all, cases, the secondary pad of a vehicle 842 is positioned at a front portion of the vehicle 842. This would be in conformity with most wireless vehicle charging standards. Accordingly, it is preferred that each of the primary pads 810 and 812 be located in the vicinity of the front of a vehicle, and thus in a forward location of its respective parking spot. For that purpose, assuming the charging station 800 is located a position where the two parking spots are adjacent to each other, if follow that the runs of the power cables will differ because the run of one, e.g., power cable 804, need only reach the primary pad at the forward position of its associated parking spot, while the other, e.g., power cable 802 need extend past the rearward portion of its associated parking spot in order to reach its primary pad. Thus, the shorter run will employ fewer cover plates than does the longer run. In the embodiment of FIG. 18-20, one cover plate 814 covers the power cable 804 while 4 covers plates 814 are needed to cover power cable 802.

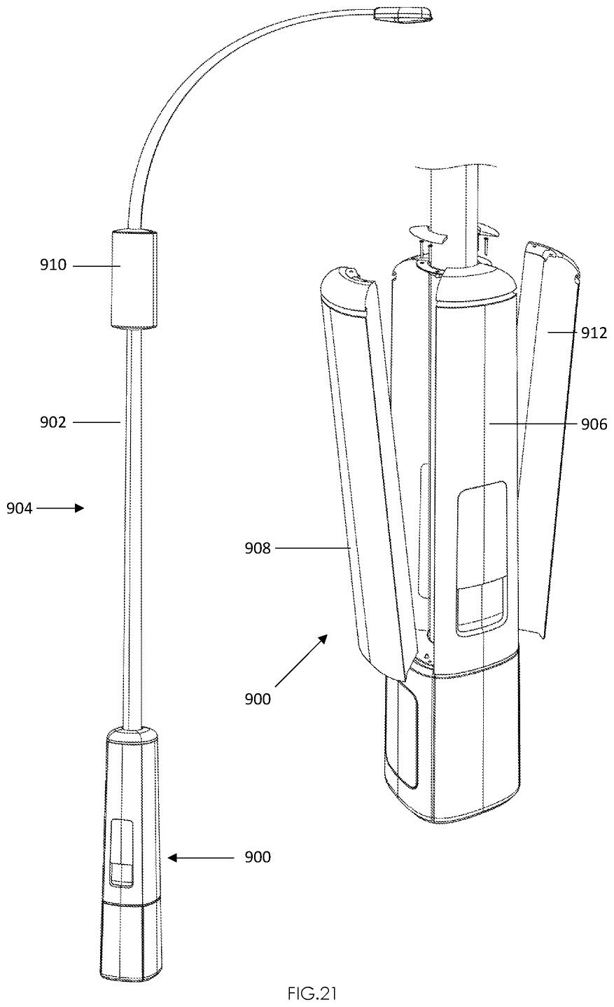

In FIG. 21, in another embodiment, a function unit 900 is mounted on a lamppost pole 902 of a lamppost 904. The function unit 900 preferably includes four modules. In the illustrated embodiment, at least one module 906 has a charging function capability as previously described. However, at least one other module 908 has a non-charging function capability relating to a wireless telecommunications system. Accordingly, the lamppost pole 902 also includes a telecommunications antenna 910 mounted on it at an appropriate height. Preferably the telecommunications system involves transmission of 5G signals and the antenna 910 is suitable for receipt and transmission of 5G signals.

A baseband processing unit (BBU) is a unit that processes baseband signals in telecommunications systems. A typical wireless telecommunications station consists of the baseband processing unit and a radio frequency processing unit (also referred to as a remote radio unit or RRU). The baseband unit typically is placed in an equipment room and connected with the RRU via an optical fiber. The BBU is responsible for communication through a physical interface. BBUs can have the following characteristics: modular design, small size, low power consumption and easily deployed.

As can be appreciated, one or more of the modules 906 can include a BBU, an RRU, or both. It is not necessary for each module to have both a BBU and an RRU and those functions can be performed in one modular station or be distributed among plural modular stations depending on system configuration. However, preferably, at least the module 908 includes a remote radio unit/RRU.

Another module 912 (and others), can have no function capability and thus serve as a dummy or filler module. However, one or more of the modules, such as the module 912, can have an environmental condition sensing capability or a non-environmental condition sensing capability. The sensors themselves and the manner in processing signals from them are well known. Also, one of the modules can have a communications function capability.

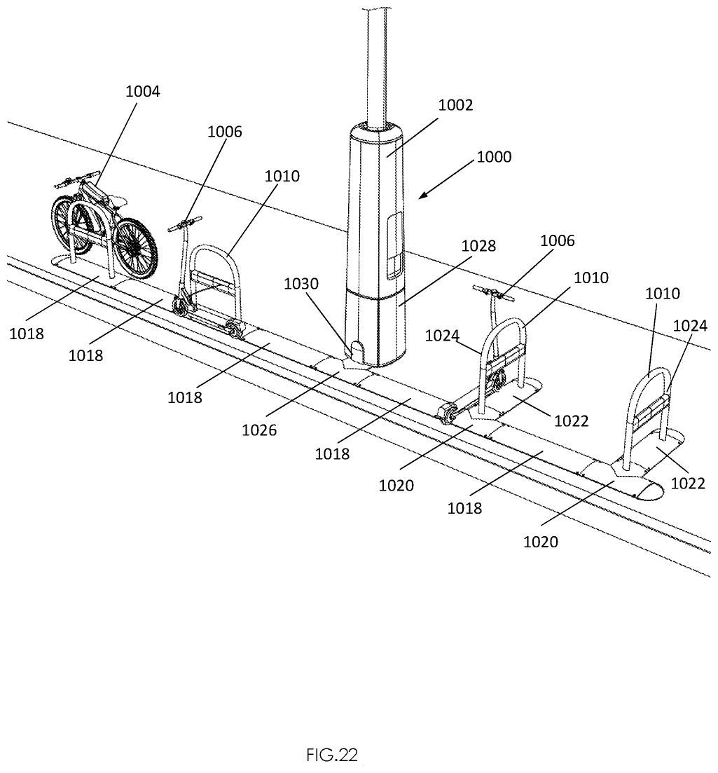

FIGS. 22-25 illustrate a charging system in which is suitable for micro-mobility devices such as electric bicycles 1004 and scooters 1006. In this exemplary embodiment, the charging system includes a function unit 1000 similar to the function unit 800, including at least one module 1002 with a charging function capability.

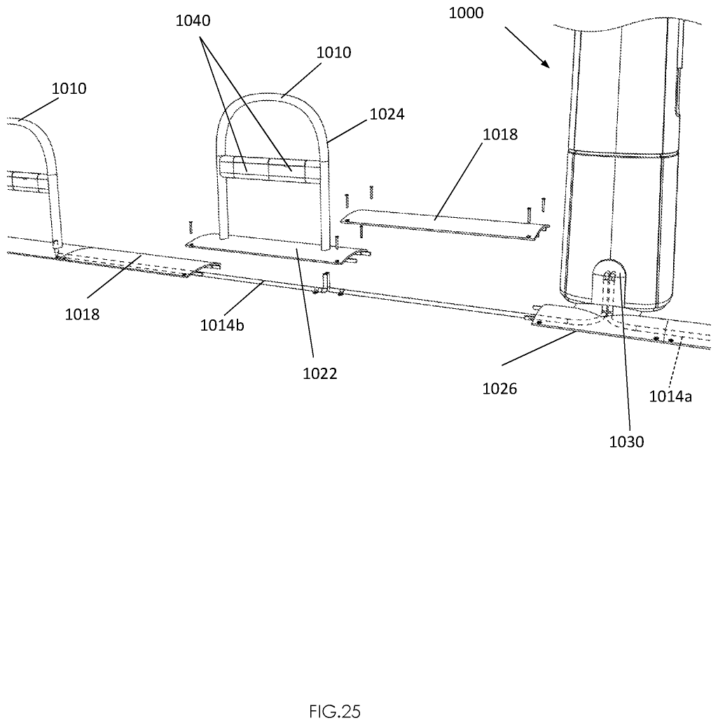

In this embodiment, racks 1010 can be disposed along a sidewalk 1012 or other suitable surface, e.g., a parking lot. Each rack 1010 includes an outlet 1012 in electrical communication with a module having charging function capability such as module 1002. The electrical communication is via one of power cables 1014a and 1014b that are disposed under a protective cover 1016 comprised of one or more cover plates 1018, 1020, and 1022 that are secured by bolts or screws 1023 to the sidewalk 1012. The cover plates 1018 extend between the racks 1018 while the cover plates 1020 cover the power cable take offs for the racks 1010. Thus, cover plates form a T-connection to a cover plate 1022. Preferably, as seen in FIG. 25, the cover plates 1022 are also the base plates of the racks 1010 such that a rack 1010 is comprised of a cover plate/base plate 1022 and a arching bar 1024.

A T-shaped cover plate 1026 covers the cable 1014 as it exits the base unit 1028 of the charging system. The cover plate 1026 includes an upstanding tab 1028 that covers an opening in the base unit 1028. The cover plate 1026 also includes and upstand tab 1030 that covers an opening in the base unit 1028 through which the cables 1014a and 1014b extend.

As can be seen, the cables 1014a and 1014b diverge under the cover plate 1026 and extend in different directions, in this illustration in opposite directions. In this way, the racks 1010 can be spaced along a length of the sidewalk 1016.

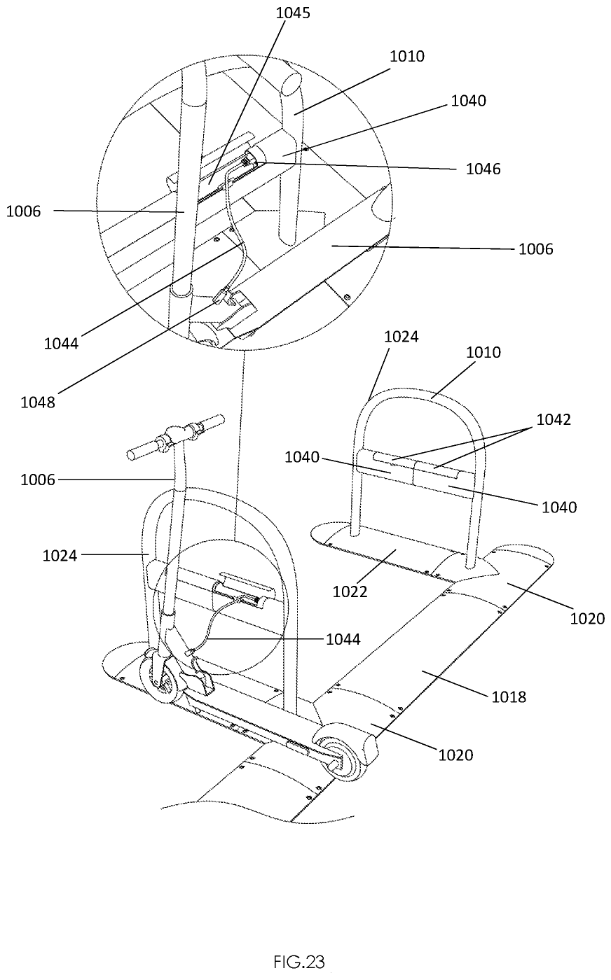

As illustrated best in FIG. 23, each rack 1010 preferably includes two charging cable containers 1040 placed end to end and spanning the distance between the two legs 1010a and 1010b of the rack. Each container 1004 includes a door 1042 and can be electronically locked using known door locking technologies. Inside the container is a space 1045 which can contain a charging cable 1044 connected to the power cable feed power to that rack. Alternatively, the charging cable may be received within an outlet 1046. Preferably the charging cable includes a plug 1048 at a plug end that conforms with the requirements of the receptacles of a large number of micro-mobility devices. Alternatively, the users of the micro-mobility devices may be permitted to bring their own charging cable and plug it into the outlet 1046, if such an outlet is provided.

As for control over management and operation of the charging system, the scheme outlined in connection with FIG. 17 can be employed. Other features similar to those described in connection with the other embodiments are not again repeated here but are easily understood from the foregoing descriptions.

One may appreciate that further modifications can be made without departing from the scope of the invention, which is defined by the claims appended hereto. Accordingly, other embodiments are within the scope of the following claims.

1. A charging station for use with a pole for charging an electric vehicle (EV) from a power delivered to inside the pole, wherein the charging station comprises:
a base unit configured to surround a base of the pole, the base unit comprising base portions, the base portions being configured to connect to each other and surround the base of the pole; and
a technical unit configured to surround an upper portion of the pole, the technical unit comprising:
a shell configured to surround the upper portion of the pole and to house electronic components therein, the electronic components being electrically connected to a power source inside the pole, and
at least one charging port accessible from outside the shell and configured to allow a charging plug to be attached thereto and thereby electrically connect the charging plug to the power source inside the pole,
wherein the shell has shell portions that are configured to connect to each other and to the upper portion of the pole and thereby enclose the upper portion of the pole, the charging port being provided in one of the shell portions.

2. The charging station of claim 1, wherein the pole is a lamppost pole.

3. The charging station of claim 1, wherein one of the base portions comprises an access door.

4-7. (canceled)

8. The charging station of claim 1, wherein the electronic components are mounted on a component housing within the shell formed from the shell portions.

9. The charging station of claim 1, wherein the electronic components comprise a power meter configured to measure the power being used at the at least one charging port.

10. The charging station of claim 1, comprising a communication system configured to communicate the power being used at the at least one charging port.

11-14. (canceled)

15. The charging station of claim 1, comprising a light that shows a status of the charging station.

16. (canceled)

17. The charging station of claim 1, wherein the charging port is a Level 1 charging port, a Level 2 charging port, or a Level 3 charging port.

18. (canceled)

19. An electric vehicle (EV) charging system, comprising:
the charging station of claim 1;
a communication network configured to receive electricity usage information from an electric meter inside the technical unit;
a charge manager connected to the communication network, configured to analyze the usage information received from the technical unit; and
a mobile application or a web application configured to allow a user to use the charging station.

20. An electric charging system comprising:
a lower bracket that can be secured to a pole at a first position at or above a base of the pole;
an upper bracket that can be secured to the pole at a second position spaced apart and above the first position;
a plurality of function unit modules that can be secured to the upper bracket to surround the pole and be supported on the lower bracket, at least one function unit module having a charging function capability.

21-23. (canceled)

24. The electric charging system of claim 20 wherein, the at least one function unit module comprises an electronic display with a transparent pane overlaying the electronic display.

25. (canceled)

26. The electric charging system of claim 20 wherein, the at least one function unit module comprises a retractable charging cable.

27-41. (canceled)

42. The electric charging station of claim 20, wherein the functional unit modules include electrical connections and electronics to provide for one or more racks configured to charge micro-mobility devices, wherein the electric charging station further includes a plurality of protective covers that are secured to a surface for the routing electrical connections to said racks.

43. The electric charging station of claim 20, wherein the functional unit modules include ground-based charging coils configured to provide wireless charging, wherein the electric charging station further includes a plurality of protective covers that are secured to a surface for the routing electrical connections to said ground-based charging coils.

44. The electric charging station of claim 20, wherein the functional unit modules include a baseband processing unit and an antenna mounted to the electric charging station and in electrical communication with the baseband processing unit, wherein the antenna and the baseband processing unit are configured to provide telecommunications around the electric charging station.
